(19) United States
(12) Patent Application Publication
(10) Pub. No.: US 2023/0365463 A1
(43) Pub. Date: Nov. 16, 2023

(54) METHOD FOR PRODUCING CHEMICALLY STRENGTHENED GLASS SUBSTRATE, METHOD FOR REWORKING CHEMICALLY STRENGTHENED GLASS SUBSTRATE, AND CHEMICALLY STRENGTHENED GLASS SUBSTRATE

(71) Applicant: AGC Inc., Tokyo (JP)

(72) Inventors: Kaname SEKIYA, Tokyo (JP); Yusuke FUJIWARA, Tokyo (JP); Akio SHIZUKAI, Tokyo (JP); Seikichi TEI, Tokyo (JP); Takashi ETO, Tokyo (JP)

(73) Assignee: AGC Inc., Tokyo (JP)

(21) Appl. No.: 18/315,592

(22) Filed: May 11, 2023

(30) Foreign Application Priority Data
May 13, 2022 (JP) 2022-079823
Oct. 17, 2022 (JP) 2022-166402
Jan. 27, 2023 (JP) 2023-011178

(51) Int. Cl. C03C 21/00; B24B 7/24

(52) U.S. Cl. CPC C03C 21/002; B24B 7/241

(57) ABSTRACT

The present invention relates to a method for producing a chemically strengthened glass substrate, the method including the following steps (A) to (C): (A) preparing a chemically strengthened glass substrate A having a main surface and an end surface; (B) obtaining a glass substrate by polishing a surface of the chemically strengthened glass substrate A; and (C) performing ion exchange by bringing the glass substrate into contact with an inorganic salt composition including 90% by mass or more of KNO₃ and 1.0% by mass or more and 6.0% by mass or less of NaNO₃ to obtain a chemically strengthened glass substrate C.

### CROSS-REFERENCE TO RELATED APPLICATIONS

This application is based on and claims priority under 35 USC 119 from Japanese Patent Application No. 2022-079823 filed on May 13, 2022, Japanese Patent Application No. 2022-166402 filed on Oct. 17, 2022, and Japanese Patent Application No. 2023-011178 filed on Jan. 27, 2023, the entire content of which is incorporated herein by reference.

### TECHNICAL FIELD

The present invention relates to a method for producing a chemically strengthened glass substrate, a method for reworking the chemically strengthened glass substrate, and the chemically strengthened glass substrate.

### BACKGROUND ART

In the related art, as cover glass for displays such as various information terminal devices, there has been used a chemically strengthened glass in which a compressive stress layer is formed on a glass surface by chemical strengthening such as ion exchange since the chemically strengthened glass is thin and resistant to cracking or the like.

Since the chemically strengthened glass includes the compressive stress layer on a surface thereof, external scratches and foreign matters on the surface may lead to an explosive breakage and a significant decrease in strength. Therefore, in some cases, if a desired appearance criterion is not satisfied after chemical strengthening, for example, external scratches or foreign matters on a surface below the criterion occur, there is no choice but to discard the chemically strengthened glass.

Defects such as external scratches and foreign matters on a surface can be removed by a polishing process. In particular, when the scratches or the foreign matters on the surface have a depth, the defect can be removed by polishing by an amount corresponding to the depth. The polishing process includes both physical polishing using a polishing material and chemical polishing (etching) by a chemical reaction using chemicals.

The defects such as scratches and foreign matters on a surface can be removed by the polishing process even for glass that has a compressive stress on a chemically strengthened surface. However, the compressive stress layer of a surface layer portion is also removed by polishing. Therefore, in the process of polishing the chemically strengthened glass, a process of forming a compressive stress layer again is required.

As a method of removing the compressive stress layer of the chemically strengthened glass and forming the compressive stress layer again, for example, Patent Literature 1 discloses a method of removing a part or all of a compressive stress layer formed on a main surface of chemically strengthened glass, and then forming a compressive stress layer again by a chemical strengthening process (hereinafter, also abbreviated as “re-strengthening”).

### CITATION LIST

### Patent Literature

Patent Literature 1: JP2010-116276A

### SUMMARY OF INVENTION

### Technical Problem

Patent Literature 1 does not disclose recycling of the chemically strengthened glass (hereinafter also abbreviated as reworking), but it is possible to readjust the compressive stress layer in that the compressive stress layer is formed again after removing the compressive stress layer.

However, when a chemical strengthening treatment is performed after the part or all of the compressive stress layer on a surface of the chemically strengthened glass is removed, ions introduced by chemical strengthening before the removal remain on the surface and an inside of the glass.

Therefore, there is a problem that if the chemical strengthening is performed in the same process, ions are supplied to the glass again to cause the glass to expand, whereby a desired substrate shape cannot be obtained. On the other hand, if a strengthening time during re-strengthening is shortened in order to reduce the expansion, an amount of ion exchange becomes insufficient, a stress in a deep layer cannot be increased, and a desired strength characteristic cannot be obtained.

Accordingly, an object of the present invention is to provide a method for producing a chemically strengthened glass substrate and a method for reworking the chemically strengthened glass substrate, in which a chemically strengthened glass substrate including scratches or foreign matters on a surface is recycled as a high-quality chemically strengthened glass having an excellent appearance and an excellent strength characteristic.

### Solution to Problem

As a result of examining the above problems, the present inventors have found that, after polishing a surface of a chemically strengthened glass substrate, the glass substrate is brought into contact with an inorganic salt composition containing a component in a specific range to perform ion exchange, whereby a compressive stress can be sufficiently introduced not only in a glass surface layer portion but also in a glass deep layer portion, and the present invention has been made.
1. A method for producing a chemically strengthened glass substrate, the method including the following steps (A) to (C):
   (A) preparing a chemically strengthened glass substrate A having a main surface and an end surface;
   (B) obtaining a glass substrate by polishing a surface of the chemically strengthened glass substrate A; and
   (C) performing ion exchange by bringing the glass substrate into contact with an inorganic salt composition including 90% by mass or more of KNO₃ and 1.0% by mass or more and 6.0% by mass or less of NaNO₃ to obtain a chemically strengthened glass substrate C.
2. A method for producing a chemically strengthened glass substrate, the method including the following steps (A) to (C):
   (A) preparing a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with an inorganic salt composition including 90% by mass or more of KNO₃, 0% by mass or more and less than 5.0% by mass of NaNO₃, and 0% by mass or more and less than 1.0% by mass of LiNO₃ to obtain a chemically strengthened glass substrate C.
3. A method for producing a chemically strengthened glass substrate, the method including the following steps (A) to (C):
   (A) bringing a glass substrate for chemical strengthening having a main surface and an end surface into contact with a primary inorganic salt composition to prepare a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with a secondary inorganic salt composition to obtain a chemically strengthened glass substrate C,
   in which,
   when a cumulative treated area of the primary inorganic salt composition in the step (A) is less than 0.2 m²/kg, the secondary inorganic salt composition in the step (C) is an inorganic salt composition including 90% by mass or more of KNO₃ and 0% by mass or more and less than 1.0% by mass of LiNO₃, and
   when the cumulative treated area of the primary inorganic salt composition in the step (A) is 0.2 m²/kg or more, the secondary inorganic salt composition in the step (C) is an inorganic salt composition including 90% by mass or more of KNO₃, 0% by mass or more and less than 5.0% by mass of NaNO₃, and 0% by mass or more and less than 1.0% by mass of LiNO₃.
4. A method for producing a chemically strengthened glass substrate, the method including the following steps (A) to (C):
   (A) bringing a glass substrate for chemical strengthening having a main surface and an end surface into contact with a primary inorganic salt composition to prepare a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with a secondary inorganic salt composition to obtain a chemically strengthened glass substrate C,
   in which,
   when a concentration of LiNO₃ in the primary inorganic salt composition in the step (A) is less than 0.8% by mass, the secondary inorganic salt composition in the step (C) is an inorganic salt composition including 90% by mass or more of KNO₃ and 0% by mass or more and less than 1.0% by mass of LiNO₃, and
   when the concentration of LiNO₃ in the primary inorganic salt composition in the step (A) is 0.8% by mass or more, the secondary inorganic salt composition in the step (C) is an inorganic salt composition including 90% by mass or more of KNO₃, 0% by mass or more and less than 5.0% by mass of NaNO₃, and 0% by mass or more and less than 1.0% by mass of LiNO₃.
5. A method for producing a chemically strengthened glass substrate, the method including the following steps (A) to (C):
   (A) preparing a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with an inorganic salt composition to obtain a chemically strengthened glass substrate C,
   in which,
   a value obtained by dividing a tensile stress CT (MPa) of the chemically strengthened glass substrate C by a tensile stress CT of the chemically strengthened glass substrate A is 0.90 or more and 1.20 or less.
6. A method for producing a chemically strengthened glass substrate, the method including the following steps (A) to (C):
   (A) bringing a glass substrate for chemical strengthening having a main surface and an end surface into contact with a primary inorganic salt composition to prepare a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with a secondary inorganic salt composition to obtain a chemically strengthened glass substrate C,
   in which,
   when a cumulative treated area of the primary inorganic salt composition in the step (A) is less than 0.2 m²/kg, a value obtained by dividing a tensile stress CT (MPa) of the chemically strengthened glass substrate C by a tensile stress CT of the chemically strengthened glass substrate A is 0.90 or more and 1.10 or less, and
   when the cumulative treated area of the primary inorganic salt composition in the step (A) is 0.2 m²/kg or more, the value obtained by dividing a tensile stress CT of the chemically strengthened glass substrate C by a tensile stress CT of the chemically strengthened glass substrate A is 0.90 or more and 1.20 or less.
7. A method for producing a chemically strengthened glass substrate, the method including the following steps (A) to (C):
   (A) bringing a glass substrate for chemical strengthening having a main surface and an end surface into contact with a primary inorganic salt composition to prepare a chemically strengthened glass substrate A having a main surface and an end surface;
   (B) obtaining a glass substrate by polishing a surface of the chemically strengthened glass substrate A; and
   (C) performing ion exchange at least once by bringing the glass substrate into contact with a secondary inorganic salt composition to obtain a chemically strengthened glass substrate C,
   in which,
   when a concentration of LiNO₃ in the primary inorganic salt composition in the step (A) is less than 0.8% by mass, a value obtained by dividing a tensile stress CT (MPa) of the chemically strengthened glass substrate C by a tensile stress CT of the chemically strengthened glass substrate A is 0.90 or more and 1.10 or less, and when the concentration of LiNO₃ in the primary inorganic salt composition in the step (A) is 0.8% by mass or more, the value obtained by dividing a tensile stress CT of the chemically strengthened glass substrate C by a tensile stress CT of the chemically strengthened glass substrate A is 0.90 or more and 1.20 or less.
8. The method for producing a chemically strengthened glass substrate according to any one of 1 to 7,
   in which,
   a value obtained by dividing a strengthening expansion coefficient of the chemically strengthened glass substrate C by a strengthening expansion coefficient of the chemically strengthened glass substrate A is 0.90 or more and 1.10 or less, the strengthening expansion coefficient being defined by the following formula,

strengthening expansion coefficient (%)={[(dimension of chemically strengthened glass substrate)−(dimension of glass substrate before chemical strengthening)]/(dimension of glass substrate before chemical strengthening)}×100.
9. The method for producing a chemically strengthened glass substrate according to any one of 1 to 8, the method further including the following step (A′) between the step (A) and the step (B):
   (A′) performing appearance inspection on the surface of the chemically strengthened glass substrate A,
   in which,
   when it is determined that a result of the appearance inspection does not satisfy a predetermined criterion, the step (B) is performed.
10. The method for producing a chemically strengthened glass substrate according to any one of 1 to 9,
   in which,
   the step (B) and the step (C) are repeated.
11. The method for producing a chemically strengthened glass substrate according to any one of 1 to 10, the method further including the following step (C′) after the step (C):
   (C′) measuring a stress value of the chemically strengthened glass substrate C, and determining whether the stress value satisfies a predetermined criterion,
   in which,
   steps of the step (B) to the step (C′) are repeated until the stress value satisfies the predetermined criterion.
12. The method for producing a chemically strengthened glass substrate according to 11, when the stress value satisfies the predetermined criterion in the step (C′), the method further including the following step (D):
   (D) performing appearance inspection of the chemically strengthened glass substrate C and determining whether a result of the appearance inspection satisfies a predetermined criterion,
   in which,
   steps of the step (B) to the step (D) are repeated until the result of the appearance inspection satisfies the predetermined criterion.
13. The method for producing a chemically strengthened glass substrate according to any one of 1 to 12,
   in which,
   in the step (B), a polishing amount per the main surface of the chemically strengthened glass substrate A is 0.5 μm or more.
14. The method for producing a chemically strengthened glass substrate according to any one of 1 to 12,
   in which,
   the chemically strengthened glass substrate A has the main surface and the end surface, the main surface includes a flat surface portion and a curved surface portion, and the end surface is formed in a direction perpendicular to the flat surface portion of the main surface, and
   the following relational expressions are satisfied:

(Xₙ/tₙ)/(X₀/t₀)>1; and

(Yₙ/tₙ)/(Y₀/t₀)>1,
provided that,
n is an integer of 1 or more,
for the chemically strengthened glass substrate A in the step (A), a distance between a point A and a point C is defined as X₀, a distance between a point B and the point C is defined as Y₀, and a maximum thickness at a flat surface portion center is defined as to,
for the chemically strengthened glass substrate C obtained by repeating steps of the step (B) to the step (D) n times, a distance between the point A and the point C is defined as Xₙ, a distance between the point B and the point C is defined as Yₙ, and a thickness at the flat surface portion center is defined as tₙ,
the point A is a most protruding portion of the end surface in a horizontal direction with respect to the flat surface portion,
the point B is a discontinuous point of the curved surface portion starting from the point A, and
the point C is an intersection point of a parallel line with respect to the flat surface portion starting from the point A and a normal line with respect to the flat surface portion starting from the point B.
15. The method for producing a chemically strengthened glass substrate according to any one of 1 to 13,
   in which,
   the chemically strengthened glass substrate A has the main surface and the end surface, and the main surface includes a flat surface portion and a bent portion, and the following relational expression is satisfied:

t_{f}/t_{c}<0.96,
provided that,
for the chemically strengthened glass substrate C obtained by repeating steps of the step (B) to the step (D) one or more times, a maximum thickness of the bent portion from an inflection point of the bent portion to the end surface is defined as t_{c} and a thickness of a flat surface portion center is defined as t_{f}.
16. A chemically strengthened glass substrate,
   having a main surface and an end surface,
   the main surface including a flat surface portion and a bent portion, and
   satisfying the following relational expression:

t_{f}′/t_{c}′<0.96,
provided that,
a maximum thickness of the bent portion from an inflection point of the bent portion to the end surface is defined as t_{c}′, and a thickness of a flat surface portion center is defined as t_{f}′.
17. The method for producing a chemically strengthened glass substrate according to any one of 1 to 15, when the step (B) and the step (C) are performed Z [times], a total polishing amount per a main surface of the chemically strengthened glass substrate C obtained in the step (C) is defined as a [μm], and a substrate thickness tolerance is defined as ±b [μm], satisfying the following relational expression:

Z[times]=a/b,
provided that Z is an integer of 1 or more.
18. The method for producing a chemically strengthened glass substrate according to any one of 1 to 15, and 17, when the step (B) and the step (C) are performed k times, a yield rate for the chemically strengthened glass substrate C obtained in the step (C) is defined as Pₖ, and a non-defective yield in the step (B) and the step (C) is defined as a, satisfying the following relational expression:

Pₖ≥Pₖ₋₁+(1−Pₖ₋₁)×a,
provided that k is an integer of 1 or more.
19. The method for producing a chemically strengthened glass substrate according to any one of 1 to 15, 17 and 18,
   in which,
   a value obtained by subtracting a defective rate in the chemically strengthened glass substrate C obtained in the step (C) from a defective rate in the chemically strengthened glass substrate A in the step (A) is 10% or more.
20. The method for producing a chemically strengthened glass substrate according to any one of 1 to 15, and 17 to 19,
   in which,
   a ratio of CS₅₀ (c) to CS₅₀ (a) represented by the following formula is 70% or more:

CS₅₀(c)/CS₅₀(a)×100, and
the chemically strengthened glass substrate C obtained in the step (C) has CS₀ of 750 MPa or more,
provided that,
a value of a compressive stress in a glass surface layer is defined as CS₀ [MPa], and a value of a compressive stress at a depth of 50 μm from a glass surface is defined as CS₅₀ [MPa], and
CS₅₀ [MPa] of the chemically strengthened glass substrate A in the step (A) is defined as CS₅₀ (a), and CS₅₀ [MPa] of the chemically strengthened glass substrate C in the step (C) is defined as CS₅₀ (c).
21. The method for producing a chemically strengthened glass substrate according to any one of 1 to 15, and 17 to 20,
   in which,
   the inorganic salt composition in the step (C) has a cumulative treated area of 0.2 m²/kg or more with respect to the glass substrate.
22. The method for producing a chemically strengthened glass substrate according to any one of 1 to 15, and 17 to 21,
   in which,
   the ion exchange in the step (C) is performed under a condition of 360° C. or higher and 450° C. or lower for 5 minutes or more and 8 hours or less.
23. A method for reworking a chemically strengthened glass substrate, the method including the following steps (A) to (C):
   (A) preparing a chemically strengthened glass substrate A having a main surface and an end surface;
   (B) obtaining a glass substrate by polishing a surface of the chemically strengthened glass substrate A; and
   (C) performing ion exchange by bringing the polished glass substrate into contact with an inorganic salt composition including 90% by mass or more of KNO₃ and 1.0% by mass or more and 6.0% by mass or less of NaNO₃ to obtain a chemically strengthened glass substrate C,
   in which,
   a ratio of CS₅₀ (c) to CS₅₀ (a) represented by the following formula is 70% or more:

CS₅₀(c)/CS₅₀(a)×100, and
the chemically strengthened glass substrate obtained in the step (C) has CS₀ of 750 MPa or more,
provided that,
a value of a compressive stress in a glass surface layer is defined as CS₀ [MPa], and a value of a compressive stress at a depth of 50 μm from a glass surface is defined as CS₅₀ [MPa], and
CS₅₀ [MPa] of the chemically strengthened glass substrate A in the step (A) is defined as CS₅₀ (a), and CS₅₀ [MPa] of the chemically strengthened glass substrate C in the step (C) is defined as CS₅₀ (c).
24. A method for reworking a chemically strengthened glass substrate, the method including the following steps (A) to (C′):
   (A) preparing a chemically strengthened glass substrate A having a main surface and an end surface;
   (B) obtaining a glass substrate by polishing a surface of the chemically strengthened glass substrate A;
   (C) performing ion exchange by bringing the polished glass substrate into contact with an inorganic salt composition including 90% by mass or more of KNO₃ and 1.0% by mass or more and 6.0% by mass or less of NaNO₃ to obtain a chemically strengthened glass substrate C; and
   (C′) measuring a stress value of the chemically strengthened glass substrate C and determining whether the stress value satisfies a predetermined criterion,
   repeating steps of the step (B) to the step (C′) until the stress value satisfies the predetermined criterion in the step (C′),
   when the stress value satisfies the predetermined criterion in the step (C′), the method further including the following step (D):
   (D) performing appearance inspection of the chemically strengthened glass substrate C and determining whether a result of the appearance inspection satisfies a predetermined criterion, and
   repeating steps of the step (B) to the step (D) until the result of the appearance inspection satisfies the predetermined criterion,
   in which,
   a value obtained by subtracting a defective rate in the chemically strengthened glass substrate C obtained in the step (C) from a defective rate in the chemically strengthened glass substrate A in the step (A) is 10% or more.
25. A method for reworking a chemically strengthened glass substrate, the method including the following steps (A) to (C′):
   (A) preparing a chemically strengthened glass substrate A having a main surface and an end surface;
   (B) obtaining a glass substrate by polishing a surface of the chemically strengthened glass substrate A;
   (C) performing ion exchange at least once by bringing the polished glass substrate into contact with an inorganic salt composition including 90% by mass or more of KNO₃, 0% by mass or more and less than 5.0% by mass of NaNO₃, and 0% by mass or more and less than 1.0% by mass of LiNO₃ to obtain a chemically strengthened glass substrate C; and
   (C′) measuring a stress value of the chemically strengthened glass substrate C and determining whether the stress value satisfies a predetermined criterion,
   repeating steps of the step (B) to the step (C′) until the stress value satisfies the predetermined criterion in the step (C′),
   when the stress value satisfies the predetermined criterion in the step (C′), the method further including the following step (D):
   (D) performing appearance inspection of the chemically strengthened glass substrate C and determining whether a result of the appearance inspection satisfies a predetermined criterion, and
   repeating steps of the step (B) to the step (D) until the result of the appearance inspection satisfies the predetermined criterion,
   in which,
   a value obtained by subtracting a defective rate in the chemically strengthened glass substrate C obtained in the step (C) from a defective rate in the chemically strengthened glass substrate A in the step (A) is 10% or more.
26. A method for producing a chemically strengthened glass substrate, the method including reducing a total discharge amount of waste by a recycling treatment including polishing and chemical strengthening.

### Advantageous Effects of Invention

According to a method for producing a chemically strengthened glass substrate and a method for reworking the same of the present invention, after a part or all of a compressive stress layer on a surface of a chemically strengthened glass substrate is removed, ion exchange is performed by using an inorganic salt composition containing a component within a specific range, whereby it is possible to effectively increase a compressive stress value not only in a glass surface layer portion but also in a glass deep layer portion. Accordingly, a chemically strengthened glass substrate that does not satisfy a desired appearance criterion after chemical strengthening can be recycled as a high-quality chemically strengthened glass substrate having an excellent appearance and an excellent strength characteristic. Further, since the chemically strengthened glass substrate that has been discarded as industrial waste in the related art can be recycled in a high quality state, a yield can be improved and the industrial waste can be reduced.

### BRIEF DESCRIPTION OF DRAWINGS

FIG. 1 is a flowchart showing one aspect according to the present embodiment.

FIG. 2A is a graph showing an example of a stress profile of a chemically strengthened glass substrate, in which a vertical axis represents a compressive stress CS [MPa], and a horizontal axis represents depth [μm] from a surface.

FIG. 2B is a graph in which CS₀ of a chemically strengthened glass substrate C obtained by partially polishing a surface of a chemically strengthened glass substrate A and then bringing the glass substrate A into contact with an inorganic salt composition to perform ion exchange is taken as a vertical axis, and a concentration of NaNO₃ in the inorganic salt composition is taken as a horizontal axis.

FIG. 2C is a graph in which CS₅₀ of the chemically strengthened glass substrate C obtained by partially polishing the surface of the chemically strengthened glass substrate A and then bringing the glass substrate A into contact with the inorganic salt composition to perform ion exchange is taken as a vertical axis, and a concentration of NaNO₃ in the inorganic salt composition is taken as a horizontal axis.

FIG. 3A is a graph showing a stress profile (CS) of a chemically strengthened glass substrate obtained by performing ion exchange after polishing using an inorganic salt composition (NaNO₃-free salt) having a cumulative treated area of 0 m²/kg with respect to the glass substrate.

FIG. 3B is a graph showing a stress profile (CS) of a chemically strengthened glass substrate obtained by performing a chemical strengthening treatment after polishing using an inorganic salt composition (NaNO₃-containing salt) that was used a plurality of times for the chemical strengthening treatment and has a cumulative treated area of 0.5 m²/kg with respect to the glass substrate.

FIG. 4A is a graph showing a stress profile (CS) of the chemically strengthened glass substrate C obtained by performing ion exchange after polishing using an inorganic salt composition (NaNO₃-free salt) having a cumulative treated area of 0 m²/kg with respect to the glass substrate.

FIG. 4B is a graph showing a stress profile (CS) of the chemically strengthened glass substrate C obtained by performing a chemical strengthening treatment after polishing using an inorganic salt composition (NaNO₃-containing salt) that was used a plurality of times for the chemical strengthening treatment and has a cumulative treated area of 0.5 m²/kg with respect to the glass substrate.

FIG. 5 is a schematic cross-sectional view showing points A to C, X, and Y according to an embodiment of the present invention, in a case in which a chemically strengthened glass substrate is a chemically strengthened glass substrate that includes a flat surface portion and a curved surface portion on a main surface and includes an end surface formed in a direction perpendicular to the flat surface portion of the main surface.

FIG. 6A to FIG. 6D are diagrams showing a change in shape of the end surface of the obtained chemically strengthened glass substrate C as the number of times of performing the step (B) and the step (C) (the number of times of polishing and reworking) increases.

FIG. 7 shows values of Xₙ, Yₙ, Xₙ/tₙ, Yₙ/tₙ, (Xₙ/tₙ)/(X₀/t₀), and (Yₙ/tₙ)/(Y₀/t₀).

FIG. 8A is a graph in which Yₙ/tₙ is a vertical axis and the number of times of polishing and reworking is a horizontal axis.

FIG. 8B is a graph in which Xₙ/tₙ is a vertical axis and the number of times of polishing and reworking is a horizontal axis.

FIG. 9A and FIG. 9B show, as an embodiment of the present invention, a flat surface portion center and a corner portion of a bent portion before and after the polishing and reworking in a case in which the chemically strengthened glass substrate is a chemically strengthened glass substrate including a flat surface portion and a bent portion on a main surface.

FIG. 10 shows, as an embodiment of the present invention, a maximum thickness t_{c} of the bent portion from an inflection point of the bent portion to an end surface, a thickness t_{f} of the flat surface portion center, and a change amount of t_{f}/t_{c} in a case in which the chemically strengthened glass substrate is the chemically strengthened glass substrate including the flat surface portion and the bent portion on the main surface.

FIG. 11 is a schematic cross-sectional view illustrating an inflection point of a bent portion, a flat surface portion center, an end surface, t_{f}, and t_{c} in a case in which the chemically strengthened glass substrate A is a chemically strengthened glass substrate including a flat surface portion and the bent portion on a main surface thereof according to an embodiment of the present invention.

FIG. 12 is a graph in which the number of times of the polishing and reworking, a yield rate (solid line), and an amount of waste (dotted line) are estimated.

FIG. 13 shows estimation results of extension of life of the inorganic salt composition in a process in the related art and a process including polishing and reworking of the present invention.

### DESCRIPTION OF EMBODIMENTS

Hereinafter, the present invention will be described in detail, but the present invention is not limited to the following embodiments, and can be freely modified and implemented without departing from the gist of the present invention.

In the present description, “to” indicating a numerical range is used in the sense of including the numerical values set forth before and after the “to” as a lower limit value and an upper limit value. Further, in the present description, a composition (content of each component) of glass will be described in terms of oxide by molar percentage unless otherwise specified.

In the present description, a method of reworking the chemically strengthened glass substrate is referred to as “polishing and reworking”.
<Stress Measuring Method>

In recent years, glass that has undergone two stages of chemical strengthening by exchanging lithium ions inside the glass with sodium ions (Li—Na exchange), and then exchanging the sodium ions inside the glass with potassium ions (Na—K exchange) on a surface layer portion of the glass has become mainstream for cover glass of a smartphone and the like.

In order to obtain a stress profile of such two-stage chemically strengthened glass in a non-destructive manner, for example, a scattered light photoelastic stress meter (hereinafter, also abbreviated as SLP), a film stress measurement (hereinafter, also abbreviated as FSM), or the like may be used in combination.

In the method using the scattered light photoelastic stress meter (SLP), a compressive stress derived from the Li—Na exchange inside the glass at a distance of several tens of m or more from a glass surface layer can be measured. On the other hand, in the method of using the film stress measurement (FSM), the compressive stress derived from Na—K exchange in the glass surface layer portion can be measured, which is present from the glass surface by several tens of m or less (for example, WO2018/056121 and WO2017/115811). Therefore, as the stress profile in the glass surface layer and inside of the two-stage chemically strengthened glass, a combination of SLP information and FSM information is sometimes used.

In the present invention, the stress profile measured mainly by the scattered light photoelastic stress meter (SLP) is used. In the present description, a compressive stress CS, a tensile stress CT, a compressive stress layer depth DOL, or the like means a value in a SLP stress profile.

The scattered light photoelastic stress meter is a stress measuring device including: a polarization phase difference variable member that changes a polarization phase difference of laser light by one wavelength or more with respect to a wavelength of the laser light; an imaging element that acquires a plurality of images by imaging, a plurality of times at predetermined time intervals, scattered light emitted when the laser beam having the varied polarization phase difference is incident on the strengthened glass; and a calculation unit that measures a periodic luminance change of the scattered light using the plurality of images, calculates a phase change of the luminance change, and calculates stress distribution in a depth direction from a surface of the strengthened glass based on the phase change.

A method for measuring the stress profile using the scattered light photoelastic stress meter includes a method described in WO2018/056121. Examples of the scattered light photoelastic stress meter include SLP-1000 and SLP-2000 manufactured by Orihara industrial co., ltd. Combining attached software SlpIV_up3 (Ver.2019.01.10.001) with these scattered light photoelastic stress meters enables highly accurate stress measurement.

<Measurement of Strengthening Expansion Coefficient>

A strengthening expansion coefficient is calculated by dividing a dimension of a glass substrate after a chemical strengthening step by a dimension of the glass substrate before the chemical strengthening step, and is an index representing how much the glass expands as a result of ion exchange in the chemical strengthening step.

The strengthening expansion coefficient was determined by the following formula.

Strengthening expansion coefficient (%)={[(dimension of chemically strengthened glass substrate)−(dimension of glass substrate before chemical strengthening)]/(dimension of glass substrate before chemical strengthening)]}×100

The dimension can be measured using an image measuring apparatus [for example, NEXIV (VMZ-S3020) manufactured by Nikon Corporation].

### Method for Producing Chemically Strengthened Glass: First to Fifth Embodiments

The first to fifth embodiments of the present invention are methods for producing chemically strengthened glass. Hereinafter, the first to fifth embodiments will be described in detail with reference to a flowchart.

The first embodiment includes the following steps (A) to (C).
(A) A step of preparing chemically strengthened glass substrate A having a main surface and an end surface
(B) A step of obtaining a glass substrate by polishing a surface of the chemically strengthened glass substrate A
(C) A step of performing ion exchange by bringing the glass substrate into contact with an inorganic salt composition containing 90% by mass or more of KNO₃ and 1.0% by mass or more and 6.0% by mass or less of NaNO₃ to obtain a chemically strengthened glass substrate C

The second embodiment includes the following steps (A) to (C).
(A) A step of preparing chemically strengthened glass substrate A having a main surface and an end surface
(B) A step of obtaining a glass substrate by polishing a surface of the chemically strengthened glass substrate A
(C) A step of performing ion exchange at least once by bringing the glass substrate into contact with an inorganic salt composition containing 90% by mass or more of KNO₃, 0% by mass or more and less than 5.0% by mass of NaNO₃, and 0% by mass or more and less than 1.0% by mass of LiNO₃ to obtain a chemically strengthened glass substrate C

The third embodiment includes the following steps (A) to (C).
(A) A step of bringing a glass substrate for chemical strengthening having a main surface and an end surface into contact with a primary inorganic salt composition to prepare a chemically strengthened glass substrate A having a main surface and an end surface
(B) A step of obtaining a glass substrate by polishing a surface of the chemically strengthened glass substrate A
(C) A step of performing ion exchange at least once by bringing the glass substrate into contact with a secondary inorganic salt composition to obtain a chemically strengthened glass substrate C In the third embodiment, when a cumulative treated area of the primary inorganic salt composition in the step (A) is less than 0.2 m²/kg, the secondary inorganic salt composition in the step (C) is an inorganic salt composition containing 90% by mass or more of KNO₃ and 0% by mass or more and less than 1.0% by mass of LiNO₃, and when the cumulative treated area of the primary inorganic salt composition in the step (A) is 0.2 m²/kg or more, the secondary inorganic salt composition in the step (C) is an inorganic salt composition containing 90% by mass or more of KNO₃, 0% by mass or more and less than 5.0% by mass of NaNO₃, and 0% by mass or more and less than 1.0% by mass of LiNO₃.

The fourth embodiment includes the following steps (A) to (C).
(A) A step of preparing chemically strengthened glass substrate A having a main surface and an end surface
(B) A step of obtaining a glass substrate by polishing a surface of the chemically strengthened glass substrate A
(C) A step of performing ion exchange at least once by bringing the glass substrate into contact with an inorganic salt composition to obtain a chemically strengthened glass substrate C In the fourth embodiment, a value obtained by dividing a tensile stress CT (MPa) of the chemically strengthened glass substrate C by a tensile stress CT of the chemically strengthened glass substrate A is 0.90 or more and 1.20 or less.

The fifth embodiment includes the following steps (A) to (C).
(A) A step of bringing a glass substrate for chemical strengthening having a main surface and an end surface into contact with a primary inorganic salt composition to prepare a chemically strengthened glass substrate A having a main surface and an end surface
(B) A step of obtaining a glass substrate by polishing a surface of the chemically strengthened glass substrate A
(C) A step of performing ion exchange at least once by bringing the glass substrate into contact with a secondary inorganic salt composition to obtain a chemically strengthened glass substrate C

In the fifth embodiment, when a cumulative treated area of the primary inorganic salt composition in the step (A) is less than 0.2 m²/kg, a value obtained by dividing a tensile stress CT (MPa) of the chemically strengthened glass substrate C by a tensile stress CT of the chemically strengthened glass substrate A is 0.90 or more and 1.10 or less, and when the cumulative treated area of the primary inorganic salt composition in the step (A) is 0.2 m²/kg or more, the value obtained by dividing the tensile stress CT of the chemically strengthened glass substrate C by the tensile stress CT of the chemically strengthened glass substrate A is 0.90 or more and 1.20 or less.

In the first to fifth embodiments, it is preferable to include a step (A′) of performing appearance inspection on the surface of the chemically strengthened glass substrate A between the step (A) and the step (B), and the step (B) is preferably performed when it is determined that a result of the appearance inspection does not satisfy a predetermined criterion.

In the first to fifth embodiments, the step (B) and the step (C) are preferably repeated. By repeating the steps (B) and (C), a chemically strengthened glass substrate having a more excellent appearance can be obtained.

In the first to fifth embodiments, it is preferable to include, after the step (C), a step (C′) of measuring a stress value of the chemically strengthened glass substrate C, and determining whether the stress value satisfies a predetermined criterion, and it is preferable to repeat the steps (B) to (C′) until the stress value satisfies the predetermined criterion. Accordingly, a chemically strengthened glass substrate having a more excellent appearance and a more excellent strengthening characteristic can be obtained.

In the first to fifth embodiments, when the stress value in the step (C′) satisfies the predetermined criterion, it is preferable to further include a step (D) of performing appearance inspection of the chemically strengthened glass substrate C and determining whether a result of the appearance inspection satisfies a predetermined criterion, and it is preferable to repeat the steps (B) to (D) until the result of the appearance inspection satisfies the predetermined criterion. Accordingly, a chemically strengthened glass substrate having a more excellent appearance and a more excellent strengthening characteristic can be obtained.

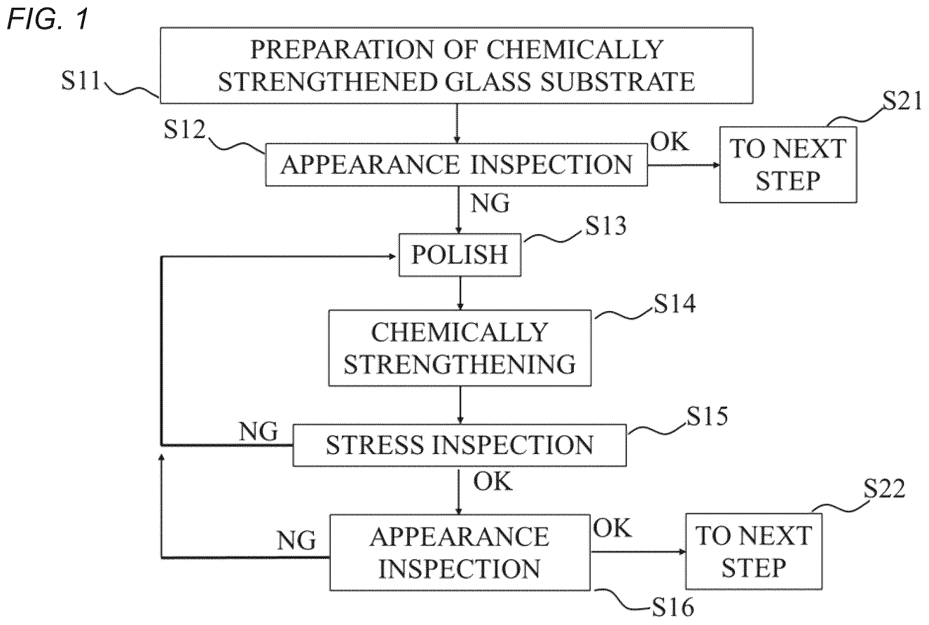

FIG. 1 is a flowchart showing an aspect of the first to fifth embodiments. In the aspect of the present embodiment, the chemically strengthened glass substrate A having the main surface and the end surface is prepared in step S11 [step (A)]. In step S12, the appearance inspection of the surface of the chemically strengthened glass substrate A is performed, and it is determined whether the result of the appearance inspection satisfies the predetermined criterion [step (A′)].

When it is determined that the result of the appearance inspection satisfies the predetermined criterion, the step proceeds to step S21 (next step) of processing the chemically strengthened glass substrate A. On the other hand, when it is determined that the result of the appearance inspection does not satisfy the predetermined criterion, the step proceeds to step S13, and the glass substrate is obtained by polishing the surface of the chemically strengthened glass substrate A [step (B)].

The glass substrate obtained in step S13 is brought into contact with the inorganic salt composition in step S14 to perform the ion exchange so as to obtain the chemically strengthened glass substrate C [step (C)]. In step S15, the stress value of the obtained chemically strengthened glass substrate C is measured, and it is determined whether the stress value satisfies the predetermined criterion [step (C′)]. When the stress value does not satisfy the predetermined criterion, it is preferable that the steps S13 to S15 are repeated until the stress value satisfies the predetermined criterion.

When the stress value satisfies the predetermined criterion in step S15, the step proceeds to step S16, the appearance inspection of the chemically strengthened glass substrate C is performed, and it is determined whether the result of the appearance inspection satisfies the predetermined criterion [step (D)]. When it is determined that the result of the appearance inspection satisfies the predetermined criterion, the step proceeds to step S22 (next step) of processing the chemically strengthened glass substrate C. On the other hand, when it is determined that the result of the appearance inspection does not satisfy the predetermined criterion, it is preferable to repeat step S13 to step S16 until the result of the appearance inspection satisfies the predetermined criterion in step S16.

Each step of the first to fifth embodiments will be described below.

<<Step (A)>>

The step (A) is a step of preparing the chemically strengthened glass substrate A having the main surface and the end surface. A composition of the chemically strengthened glass substrate A may be any composition as long as the composition can be molded and strengthened by chemical strengthening treatment. Examples thereof include aluminosilicate glass, soda lime glass, borosilicate glass, lead glass, alkali barium glass, aluminoborosilicate glass, and the like. These glass may be crystallized glass or amorphous glass.

Examples of the composition of the chemically strengthened glass substrate A include the following composition.

(1) A glass containing in terms of oxide by molar percentage: 50% to 80% SiO₂, 2% to 25% Al₂O₃, 0.1% to 20% Li₂O, 0.1% to 18% Na₂O, 0% to 10% K₂O, 0% to 15% MgO, 0% to 5% CaO, 0% to 5% P₂O₅, 0% to 5% B₂O₃, 0% to 5% Y₂O₃, and 0% to 5% ZrO₂.

A method for producing the chemically strengthened glass substrate A is not particularly limited. Specifically, for example, predetermined glass raw materials are put into a continuous melting furnace, heated and melted at 1500° C. to 1600° C., clarified, and supplied to a molding apparatus, molten glass is molded into a sheet shape, and slowly cooled to obtain a produced glass substrate. The obtained glass substrate is brought into contact with the inorganic salt composition to perform the ion exchange treatment, and a compressive stress layer is formed on a surface layer of the glass substrate, thereby obtaining the chemically strengthened glass substrate A. In the third embodiment and the fifth embodiment, the inorganic salt composition is referred to as the primary inorganic salt composition.

Examples of a method for forming the glass substrate include a down-draw method (for example, an overflow down-draw method, a slot-down method, and a re-draw method), a float method, a roll-out method, and a pressing method.

Examples of a method of bringing the glass substrate into contact with the inorganic salt composition include a method in which a paste of an inorganic salt composition is applied to a glass substrate, a method in which an aqueous solution of an inorganic salt composition is sprayed onto a glass substrate, and a method in which a glass substrate is immersed in a salt bath of a molten salt of an inorganic salt composition heated to a temperature equal to or higher than a melting point. Among these, from the viewpoint of improving productivity, a method for immersing the glass substrate in molten salt of the inorganic salt composition is preferable.

The chemical strengthening treatment by the method for immersing the glass substrate in the molten salt of the inorganic salt composition can be performed, for example, by the following procedure. First, the glass substrate is preheated to 100° C. or higher, and the molten salt is adjusted to a temperature at which chemical strengthening is performed. Next, the preheated glass substrate is immersed in the molten salt for a predetermined time, and then the glass substrate is pulled up from the molten salt and cooled.

A thickness of the chemically strengthened glass substrate A is not particularly limited, and is preferably 5 mm or less, more preferably 3 mm or less, still more preferably 1 mm or less, and particularly preferably 0.85 mm or less, from the viewpoint of further exhibiting a chemical strengthening characteristic. Further, a lower limit of the thickness of the chemically strengthened glass substrate is not particularly limited, and is preferably 0.1 mm or more, more preferably 0.2 mm or more, and still more preferably 0.3 mm or more.

The chemically strengthened glass substrate A includes, for example, a flat sheet shape having a uniform thickness, and a three-dimensional shape including a curved surface portion or a bent portion at least in part, such as 2.5D cover glass and 3D cover glass typified by smartphones. In the case in which the glass is a chemically strengthened glass having a three-dimensional shape, if there are scratches on an outer surface or foreign matters on a surface, particularly in a flat portion other than the curved surface portion or the bent portion, it is likely to cause a defect.

In the present embodiment, in the case of such a chemically strengthened glass substrate having the three-dimensional shape, it is particularly easy to exhibit an effect of preventing expansion of the glass and recycling the chemically strengthened glass substrate with high quality.

Examples of the chemically strengthened glass substrate having the three-dimensional shape include a glass substrate including a curved surface portion having a radius of curvature of 100 mm or less at least in part. Specifically, examples of the glass substrate include a glass substrate having a three-dimensional shape in which two opposing sides of a rectangular glass substrate in plan view are curved, and a glass substrate having a three-dimensional shape in which a periphery including four corners of the rectangular glass substrate is curved.

The chemical strengthening treatment for forming the compressive stress layer on the surface layer of the glass substrate is a treatment in which the glass substrate is brought into contact with the inorganic salt composition to replace metal ions in the glass with metal ions in the inorganic salt composition having a larger ionic radius than the metal ions.

A compressive stress value (CS₀) of the compressive stress layer in an outermost layer of the chemically strengthened glass substrate A is not particularly limited, and is preferably 500 MPa or more, more preferably 600 MPa or more, and still more preferably 700 MPa or more.

The compressive stress value and a depth of the compressive stress layer of the chemically strengthened glass substrate A can be measured by the film stress measurement (for example, FSM-6000 manufactured by Orihara industrial co., ltd.) and the scattered light photoelastic stress meter (for example, SLP-2000 manufactured by Orihara industrial co., ltd.).

<<Step (A′)>>

The step (A′) is a step of performing the appearance inspection of the surface of the chemically strengthened glass substrate A and determining whether the result of the appearance inspection satisfies the predetermined criterion.

Examples of the chemically strengthened glass substrate in which the result of the appearance inspection satisfies the predetermined criterion include a chemically strengthened glass substrate in which, when the appearance is observed under the following conditions, appearance defects such as observable scratches and foreign matters on the surface are preferably 3 or less, more preferably 2 or less, still more preferably 1 or less, and particularly preferably 0.

Condition: an appearance of a substrate having a size of cover glass for a smartphone is observed by setting a distance between the glass and eyes of a determination person to 30 cm under illumination of 2000 lux in a darkroom environment.

Examples of a scratch that is an observable defect include a scratch having a width of 0.1 mm, a scratch having a width of 0.05 mm to 0.1 mm and a length of 1 mm or more, or the like, under the above environment.

<<Step (B)>>

The step (B) is a step of polishing the surface of the chemically strengthened glass substrate A to obtain a glass substrate from which a part or all of the compressive stress layer is removed. In the present embodiment, it is preferable to perform the step (B) when it is determined in the step (A′) that the result of the appearance inspection does not satisfy the predetermined criterion.

By polishing the surface of the chemically strengthened glass substrate A, microscopic scratches on the surface of the glass substrate are removed, and surface strength of the glass substrate after the chemical strengthening can be improved. A polishing amount of the surface of the chemically strengthened glass substrate A in the step (B) is not particularly limited, and the polishing amount per main surface is preferably 0.5 μm or more, more preferably 3 μm or more, and still more preferably 5 μm or more. Further, the polishing amount in the step (B) is usually 10 μm or less.

In the step (B), from the viewpoint of preventing warpage of the glass, it is preferable to polish by the same polishing amount for two main surfaces of the glass substrate facing each other in a thickness direction. A polishing condition is not particularly limited, and the polishing may be performed under a condition that provide desired surface roughness.

Examples of a polishing method include a physical polishing method and a chemical polishing method. Examples of the physical polishing method include a method of polishing the surface of the glass substrate using abrasive grains.

Examples of the abrasive grains used in the physical polishing method include abrasive grains such as cerium oxide and colloidal silica. An average particle diameter of the abrasive grains is preferably 0.02 μm to 2.0 μm, and more preferably 0.04 μm to 1.5 μm. The average particle diameter of the abrasive grains can be measured by a particle diameter measuring apparatus using laser diffracting and scattering. As for a concentration of the abrasive grains, a specific gravity as slurry is preferably 1.03 to 1.13, and more preferably 1.05 to 1.10. A polishing pressure is preferably from 6 kPa to 20 kPa, and more preferably from 8 kPa to 18 kPa. As for a rotation speed of a surface table of a polishing apparatus, a peripheral speed of an outermost circumference is preferably 20 μm/min to 100 μm/min, and more preferably 30 μm/min to 70 μm/min.

Specifically, an example of the method is preparing slurry having a specific gravity of 1.07 by dispersing cerium oxide having an average particle diameter of about 1.2 μm in water, and polishing a surface of the glass substrate to result in a polishing amount of 0.5 μm or more per one surface under a condition of a polishing pressure of 9.8 kPa using a polishing pad with a non-woven fabric surface or suede surface.

For the polishing, the polishing pad having a Shore A hardness of 25° to 65° and a sinking amount at 100 g/cm² of 0.05 mm or more and having the non-woven fabric surface or suede surface can be used. Among them, from the viewpoint of cost efficiency, it is preferable to use a non-woven fabric polishing pad.

Examples of a chemical method include a method of polishing the glass surface by immersing the glass substrate in a solution containing hydrofluoric acid or the like and etching the glass substrate.

The producing method preferably further includes a cleaning step of cleaning the glass substrate between the steps (B) and (C). In the cleaning step, industrial water, ion exchange water, or the like can be used, and among them, the ion exchange water is preferably used.

A cleaning condition varies depending on a cleaning liquid, and when the ion exchange water is used, cleaning at a temperature of 0° C. to 100° C. is preferable from the viewpoint of completely removing adhering salts. In the cleaning step, various methods such as a method of immersing glass in a water tank containing ion exchange water or the like, a method of exposing a glass surface to flowing water, and a method of spraying a cleaning liquid toward a glass surface by a shower can be used.

<<Step (C)>>

The step (C) is a step of bringing the glass substrate of which the surface is polished in the step (B) into contact with the inorganic salt composition to perform ion exchange and introducing the compressive stress to the surface layer of the glass substrate so as to obtain the chemically strengthened glass substrate C. In the third and fifth embodiments, the inorganic salt composition is referred to as the secondary inorganic salt composition.

### First Embodiment

In the first embodiment, the step (C) is a step of bringing the glass substrate obtained in the step (B) into contact with the inorganic salt composition containing 90% by mass or more of KNO₃ and 1.0% by mass or more and 6.0% by mass or less of NaNO₃ to perform the ion exchange so as to obtain the chemically strengthened glass substrate C.

In the first embodiment, a content of KNO₃ in the inorganic salt composition used in the step (C) is 90% by mass or more, preferably 91% by mass or more, more preferably 92% by mass or more, particularly preferably 93% by mass or more, and most preferably 95% by mass or more. When the content of KNO₃ in the inorganic salt composition is 90% by mass or more, an amount of K ions present on the glass surface reduced by the polishing in the step (B) can be efficiently increased, and strength of the chemically strengthened glass can be improved.

In the first embodiment, a content of NaNO₃ in the inorganic salt composition used in the step (C) is 1.0% by mass or more, preferably 1.3% by mass or more, more preferably 1.5% by mass or more, and still more preferably 2.0% by mass or more. In the first embodiment, by setting the content of NaNO₃ of the inorganic salt composition to 1.0% by mass or more, a stress of a glass deep layer portion can be increased, and the strength of the chemically strengthened glass substrate can be improved.

On the other hand, when the content of NaNO₃ in the inorganic salt composition used in the step (C) is excessive, a stress on the glass surface decreases, and therefore, in the first embodiment, the content of NaNO₃ in the inorganic salt composition is 6.0% by mass or less, preferably 5.8% by mass or less, more preferably 5.5% by mass or less, still more preferably 5.0% by mass or less, and particularly preferably 4.0% by mass or less.

### Second Embodiment

In the second embodiment, the step (C) is a step of performing the ion exchange at least once by bringing the glass substrate obtained in the step (B) into contact with the inorganic salt composition containing 90% by mass or more of KNO₃, 0% by mass or more and less than 5.0% by mass of NaNO₃, and 0% by mass or more and less than 1.0% by mass of LiNO₃ to obtain the chemically strengthened glass substrate C.

In the second embodiment, a content of KNO₃ in the inorganic salt composition used in the step (C) is 90% by mass or more, preferably 91% by mass or more, more preferably 92% by mass or more, particularly preferably 93% by mass or more, and most preferably 95% by mass or more. When the content of KNO₃ in the inorganic salt composition is 90% by mass or more, an amount of K ions present on the glass surface reduced by the polishing in the step (B) can be efficiently increased, and strength of the chemically strengthened glass can be improved.

In the second embodiment, the content of NaNO₃ in the inorganic salt composition used in the step (C) is 0% by mass or more, preferably 0.1% by mass or more, more preferably 0.2% by mass or more, and still more preferably 0.3% by mass or more. In the second embodiment, by setting the content of NaNO₃ of the inorganic salt composition to 0% by mass or more, the stress of the glass deep layer portion can be increased, and the strength of the chemically strengthened glass substrate can be improved.

On the other hand, when the content of NaNO₃ in the inorganic salt composition used in the step (C) is excessive, the stress on the glass surface decreases, and therefore, in the second embodiment, the content of NaNO₃ in the inorganic salt composition is less than 5.0% by mass, preferably 4.0% by mass or less, more preferably 3.0% by mass or less, still more preferably 2.5% by mass or less, and particularly preferably 2.0% by mass or less.

In the second embodiment, with respect to a compressive stress CS₅₀ (MPa) at a depth of 50 μm from the surface, a value obtained by dividing CS₅₀ of the chemically strengthened glass substrate C by CS₅₀ of the chemically strengthened glass substrate A is preferably 0.80 or more and 1.10 or less. The value is preferably 0.82 or more, more preferably 0.84 or more, and still more preferably 0.86 or more. Further, the value is preferably 1.10 or less, more preferably 1.08 or less, and still more preferably 1.06 or less. When the value is within the above described range, it is possible to effectively increase the compressive stress value not only in the glass surface layer portion but also in the glass deep layer portion.

In the second embodiment, as for a tensile stress CT (MPa), a value obtained by dividing CT of the chemically strengthened glass substrate C by CT of the chemically strengthened glass substrate A is preferably 0.90 or more and 1.10 or less. The value is preferably 0.92 or more, more preferably 0.94 or more, and still more preferably 0.96 or more. Further, the value is preferably 1.08 or less, more preferably 1.06 or less, and still more preferably 1.04 or less. When the value is within the above range, it is possible to prevent an increase in CT.

### Third Embodiment

In the third embodiment, the step (C) is a step of performing the ion exchange at least once by bringing the glass substrate obtained in the step (B) into contact with the secondary inorganic salt composition so as to obtain the chemically strengthened glass substrate C.

In the third embodiment, a content of KNO₃ in the secondary inorganic salt composition used in the step (C) is 90% by mass or more, preferably 91% by mass or more, more preferably 92% by mass or more, particularly preferably 93% by mass or more, and most preferably 95% by mass or more. When the content of KNO₃ in the secondary inorganic salt composition is 90% by mass or more, an amount of K ions present on the glass surface reduced by the polishing in the step (B) can be efficiently increased, and strength of the chemically strengthened glass can be improved.

In the third embodiment, when a cumulative treated area of the primary inorganic salt composition in the step (A) is less than 0.2 m²/kg, the secondary inorganic salt composition in the step (C) is an inorganic salt composition containing 90% by mass or more of KNO₃ and 0% by mass or more and less than 1.0% by mass of LiNO₃. In such a case, the content of LiNO₃ in the secondary inorganic salt composition is preferably 0.01% by mass or more, more preferably 0.02% by mass or more, and still more preferably 0.04% by mass or more. Further, the content of LiNO₃ in the secondary inorganic salt composition is preferably 0.80% by mass or less, more preferably 0.60% by mass or less, and still more preferably 0.40% by mass or less.

In the third embodiment, when the cumulative treated area of the primary inorganic salt composition in the step (A) is 0.2 m²/kg or more, the secondary inorganic salt composition in the step (C) is an inorganic salt composition containing 90% by mass or more of KNO₃, 0% by mass or more and less than 5.0% by mass of NaNO₃, and 0% by mass or more and less than 1.0% by mass of LiNO₃. In such a case, a content of NaNO₃ in the secondary inorganic salt composition is preferably 0.10% by mass or more, more preferably 0.30% by mass or more, and still more preferably 0.60% by mass or more. Further, the content of NaNO₃ in the secondary inorganic salt composition is preferably less than 5.0% by mass, and more preferably 4.5% by mass or less. In such a case, the content of LiNO₃ in the secondary inorganic salt composition is preferably 0.01% by mass or more, more preferably 0.03% by mass or more, and still more preferably 0.05% by mass or more. Further, the content of LiNO₃ in the secondary inorganic salt composition is preferably 0.40% by mass or less, more preferably 0.20% by mass or less, and still more preferably 0.10% by mass or less.

In the third embodiment, as described above, conditions of the ion exchange in the step (C) are selectively used depending on the cumulative treated area of the primary inorganic salt composition used in the step (A). The present inventors have found that the cumulative treated area of the primary inorganic salt composition used in the step (A) affects the stress of the glass substrate subjected to the step (C), and a tendency of a stress characteristic of the chemically strengthened glass substrate obtained in the step (C) changes between a case in which the cumulative treated area is less than 0.2 m²/kg and a case in which the cumulative treated area is 0.2 m²/kg or more. Therefore, according to the third embodiment, by setting the composition of the secondary inorganic salt composition used in the step (C) to the above-mentioned range in accordance with a range of the cumulative treated area, it is possible to appropriately adjust an ion concentration in the secondary inorganic salt composition and it is possible to effectively increase the compressive stress value not only in the glass surface layer portion but also in the glass deep layer portion, and to prevent an increase in CT.

In the third embodiment, with respect to a compressive stress CS₅₀ (MPa) at a depth of 50 μm from the surface, a value obtained by dividing CS₅₀ of the chemically strengthened glass substrate C by CS₅₀ of the chemically strengthened glass substrate A is preferably 0.80 or more and 1.10 or less. The value is more preferably 0.82 or more, still more preferably 0.84 or more, and particularly preferably 0.86 or more. Further, the value is more preferably 1.08 or less, still more preferably 1.06 or less, and particularly preferably 1.04 or less. It is possible to effectively increase the compressive stress value not only in the glass surface layer portion but also in the glass deep layer portion.

In the third embodiment, as for a tensile stress CT (MPa), a value obtained by dividing CT of the chemically strengthened glass substrate C by CT of the chemically strengthened glass substrate A is preferably 0.90 or more and 1.20 or less. The value is preferably 0.92 or more, more preferably 0.94 or more, and still more preferably 0.96 or more. Further, the value is preferably 1.08 or less, more preferably 1.06 or less, and still more preferably 1.04 or less. When the value is within the above range, it is possible to prevent an increase in CT.

In the third embodiment, the cumulative treated area of the primary inorganic salt composition of 0.2 m²/kg indicates that a concentration of LiNO₃ in the primary inorganic salt composition is 0.8% by mass. That is, an aspect of the third embodiment includes the following aspect.

A method for producing a chemically strengthened glass substrate, including:
(A) bringing a glass substrate for chemical strengthening having a main surface and an end surface into contact with a primary inorganic salt composition to prepare a chemically strengthened glass substrate A having a main surface and an end surface;
(B) obtaining a glass substrate by polishing a surface of the chemically strengthened glass substrate A; and
(C) performing ion exchange at least once by bringing the glass substrate into contact with a secondary inorganic salt composition to obtain a chemically strengthened glass substrate C, in which
when a concentration of LiNO₃ in the primary inorganic salt composition in the step (A) is less than 0.8% by mass, the secondary inorganic salt composition in the step (C) is an inorganic salt composition containing 90% by mass or more of KNO₃ and 0% by mass or more and less than 1.0% by mass of LiNO₃, and
When the concentration of LiNO₃ in the primary inorganic salt composition in the step (A) is 0.8% by mass or more, the secondary inorganic salt composition in the step (C) is an inorganic salt composition containing 90% by mass or more of KNO₃, 0% by mass or more and less than 5.0% by mass of NaNO₃, and 0% by mass or more and less than 1.0% by mass of LiNO₃.

### Fourth Embodiment

In the fourth embodiment, as for a compressive stress CS₅₀ (MPa) at a depth of 50 m from the surface, a value obtained by dividing CS₅₀ of the chemically strengthened glass substrate C by CS₅₀ of the chemically strengthened glass substrate A is preferably 0.90 or more and 1.20 or less. The value is more preferably 0.92 or more, still more preferably 0.94 or more, and particularly preferably 0.96 or more. Further, the value is more preferably 1.18 or less, still more preferably 1.16 or less, and particularly preferably 1.14 or less. When the value is within the above described range, it is possible to effectively increase the compressive stress value not only in the glass surface layer portion but also in the glass deep layer portion.

### Fifth Embodiment

In the fifth embodiment, the step (C) is a step of bringing the glass substrate obtained in the step (B) into contact with the secondary inorganic salt composition to perform the ion exchange at least once so as to obtain the chemically strengthened glass substrate C.

In the fifth embodiment, when the cumulative treated area of the primary inorganic salt composition in the step (A) is less than 0.2 m²/kg, as for the tensile stress CT (MPa), the value obtained by dividing CT of the chemically strengthened glass substrate C by CT of the chemically strengthened glass substrate A is preferably 0.90 or more and 1.10 or less. The value is preferably 0.92 or more, more preferably 0.94 or more, and still more preferably 0.96 or more. Further, the value is preferably 1.08 or less, more preferably 1.06 or less, and still more preferably 1.04 or less. When the value is within the above range, it is possible to prevent an increase in CT.

In the fifth embodiment, when the cumulative treated area of the primary inorganic salt composition in the step (A) is less than 0.2 m²/kg, a value obtained by dividing CS₅₀ of the chemically strengthened glass substrate C by CS₅₀ of the chemically strengthened glass substrate A is preferably 0.80 or more and 1.10 or less. The value is more preferably 0.80 or more, still more preferably 0.82 or more, particularly preferably 0.84 or more, and most preferably 0.86 or more. The value is more preferably 1.08 or less, still more preferably 1.06 or less, particularly preferably 1.04 or less, and most preferably 1.02 or less.

In the fifth embodiment, when the cumulative treated area of the primary inorganic salt composition in the step (A) is 0.2 m²/kg or more, as for the tensile stress CT (MPa), the value obtained by dividing CT of the chemically strengthened glass substrate C by CT of the chemically strengthened glass substrate A is preferably 0.90 or more and 1.20 or less. The value is preferably 0.92 or more, more preferably 0.94 or more, and still more preferably 0.96 or more. Further, the value is preferably 1.18 or less, more preferably 1.16 or less, and still more preferably 1.14 or less. When the value is within the above range, it is possible to prevent the increase in CT.

In the fifth embodiment, when the cumulative treated area of the primary inorganic salt composition in the step (A) is 0.2 m²/kg or more, the value obtained by dividing CS₅₀ of the chemically strengthened glass substrate C by CS₅₀ of the chemically strengthened glass substrate A is preferably 0.80 or more and 1.20 or less. The value is more preferably 0.80 or more, still more preferably 0.82 or more, particularly preferably 0.84 or more, and most preferably 0.86 or more. The value is more preferably 1.18 or less, still more preferably 1.16 or less, particularly preferably 1.14 or less, and most preferably 1.12 or less.

In the fifth embodiment, as described above, according to the cumulative treated area of the primary inorganic salt composition used in the step (A), the range of the value obtained by dividing CT of the chemically strengthened glass substrate C by CT of the chemically strengthened glass substrate A is set, and preferably, the value obtained by dividing CS₅₀ of the chemically strengthened glass substrate C by CS₅₀ of the chemically strengthened glass substrate A is set. The present inventors have found that the cumulative treated area of the primary inorganic salt composition used in the step (A) affects the stress of the glass substrate subjected to the step (C), and a tendency of a stress characteristic of the chemically strengthened glass substrate obtained in the step (C) changes between a case in which the cumulative treated area is less than 0.2 m²/kg and a case in which the cumulative treated area is 0.2 m²/kg or more. Therefore, according to the fifth embodiment, CT and CS₅₀ of the chemically strengthened glass substrate C obtained in the step (C) can be appropriately adjusted according to the range of the cumulative treated area, and it is possible to effectively increase the compressive stress value not only in the glass surface layer portion but also in the glass deep layer portion, and to prevent the increase in CT.

In the fifth embodiment, the stress characteristics (CS₅₀ and CT) of the chemically strengthened glass substrate can be appropriately adjusted by the composition of the secondary inorganic salt composition used for the ion exchange, a temperature and a time of the ion exchange, and the like. In the fifth embodiment, a content of KNO₃ in the secondary inorganic salt composition used in the step (C) is preferably 90% by mass or more, more preferably 91% by mass or more, still more preferably 92% by mass or more, particularly preferably 93% by mass or more, and most preferably 95% by mass or more. When the content of KNO₃ in the secondary inorganic salt composition is 90% by mass or more, an amount of K ions present on the glass surface reduced by the polishing in the step (B) can be efficiently increased, and strength of the chemically strengthened glass can be improved.

In the fifth embodiment, the content of NaNO₃ in the secondary inorganic salt composition used in the step (C) is preferably 1.0% by mass or more, more preferably 1.3% by mass or more, still more preferably 1.5% by mass or more, and particularly preferably 2.0% by mass or more. In the fifth embodiment, by setting the content of NaNO₃ of the secondary inorganic salt composition to 1.0% by mass or more, a stress of a glass deep layer portion can be increased, and the strength of the chemically strengthened glass substrate can be improved.

In the fifth embodiment, when the content of NaNO₃ in the secondary inorganic salt composition used in the step (C) is excessive, the stress on the glass surface decreases, and therefore, in the fifth embodiment, the content of NaNO₃ in the secondary inorganic salt composition is preferably 6.0% by mass or less, more preferably 5.8% by mass or less, still more preferably 5.5% by mass or less, particularly preferably 5.0% by mass or less, and most preferably 4.0% by mass or less.

In the fifth embodiment, the content of LiNO₃ in the secondary inorganic salt composition used in the step (C) is preferably 0% by mass or more, more preferably 0.02% by mass or more, still more preferably 0.04% by mass or more, and particularly preferably 0.06% by mass or more. Further, the content of LiNO₃ in the secondary inorganic salt composition is preferably less than 1.0% by mass, more preferably 0.80% by mass or less, and still more preferably 0.60% by mass or less. By setting ranges of composition of the secondary inorganic salt composition to the above-mentioned ranges, it is possible to appropriately adjust an ion concentration in the secondary inorganic salt composition and it is possible to effectively increase the compressive stress value not only in the glass surface layer portion but also in the glass deep layer portion.

In the fifth embodiment, the cumulative treated area of the primary inorganic salt composition of 0.2 m²/kg indicates that a concentration of LiNO₃ in the primary inorganic salt composition is 0.8% by mass. That is, an aspect of the fifth embodiment includes the following aspect.

A method for producing a chemically strengthened glass substrate, including:
(A) bringing a glass substrate for chemical strengthening having a main surface and an end surface into contact with a primary inorganic salt composition to prepare a chemically strengthened glass substrate A having a main surface and an end surface;
(B) obtaining a glass substrate by polishing a surface of the chemically strengthened glass substrate A; and
(C) performing ion exchange at least once by bringing the glass substrate into contact with a secondary inorganic salt composition to obtain a chemically strengthened glass substrate C, in which
when a concentration of LiNO₃ of the primary inorganic salt composition in the step (A) is less than 0.8% by mass, the value obtained by dividing a tensile stress CT (MPa) of the chemically strengthened glass substrate C by CT of the chemically strengthened glass substrate A is 0.90 or more and 1.10 or less, and
when the concentration of LiNO₃ of the primary inorganic salt composition in the step (A) is 0.8% by mass or more, the value obtained by dividing CT of the chemically strengthened glass substrate C by CT of the chemically strengthened glass substrate A is 0.90 or more and 1.20 or less.

### First to Fifth Embodiments

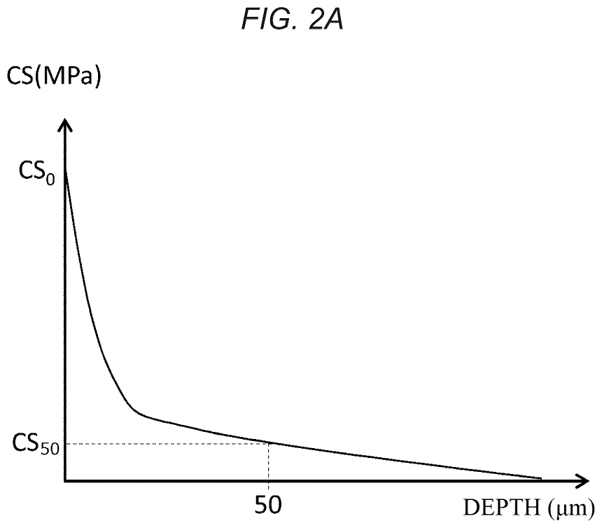

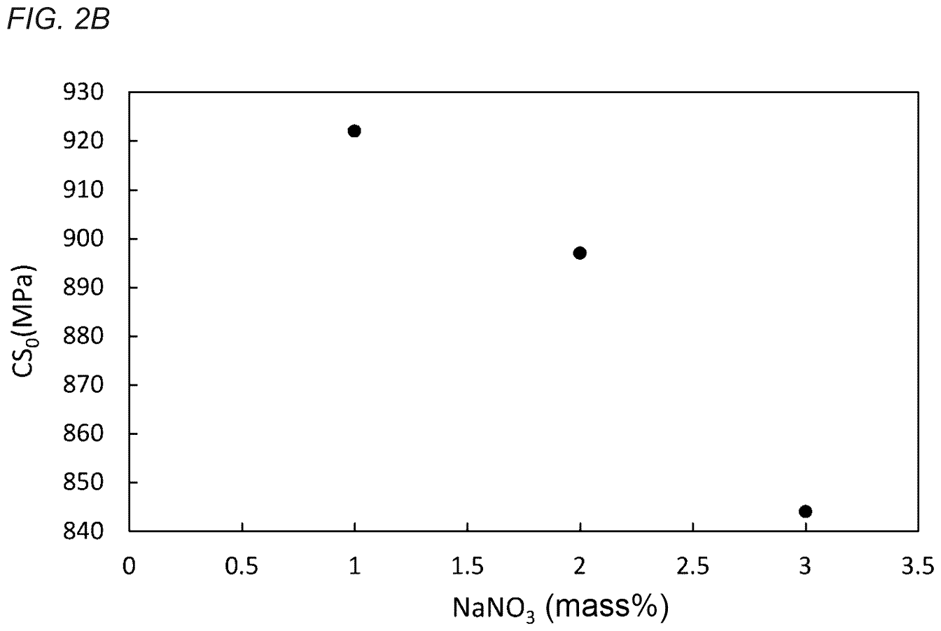

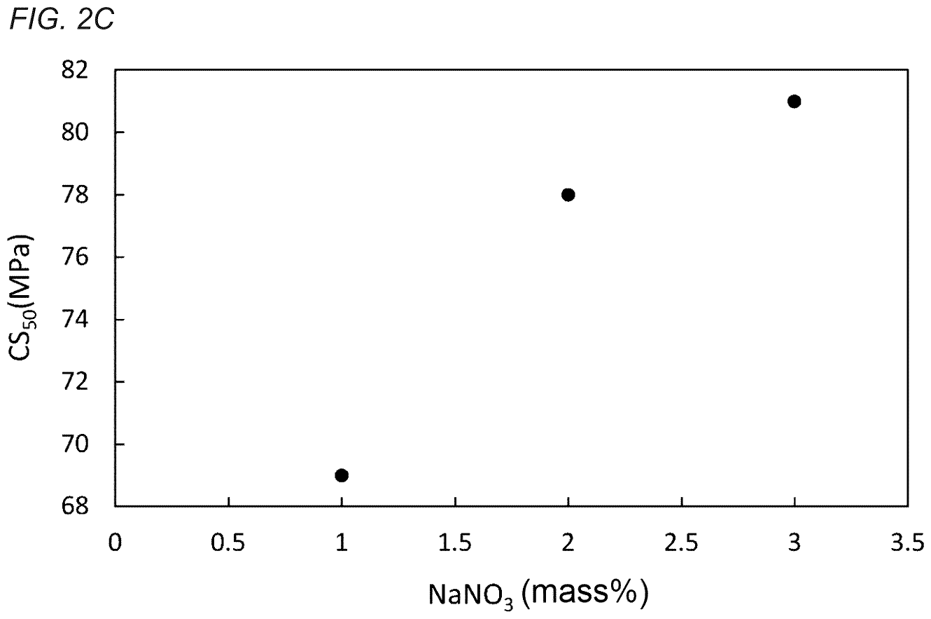

FIG. 2A is a graph showing an example of the stress profile of the chemically strengthened glass substrate, in which a vertical axis represents the compressive stress CS [MPa], and a horizontal axis represents a depth [μm] from the surface. In FIG. 2A, a value represented by the “CS₀” is a compressive stress value of an outermost surface of the glass, and a value represented by the “CS₅₀” is a compressive stress value at a depth of 50 μm.

When a part or all of the compressive stress layer on a surface of the chemically strengthened glass substrate is removed by polishing and then the chemically strengthened glass substrate is subjected to a chemical strengthening treatment, ions remain on the surface and an inside of the glass. Therefore, when the chemical strengthening is performed in the same process, there is a problem that ions are again supplied to the glass to expand the glass, and thus a desired shape cannot be obtained.

The present inventors have found that in the ion exchange after removing a part of the compressive stress layer on the surface of the chemically strengthened glass substrate by polishing, a compressive stress of the obtained chemically strengthened glass substrate changes depending on a concentration of NaNO₃ contained in the inorganic salt composition. FIG. 2B is a graph in which CS₀ of the chemically strengthened glass substrate obtained by partially polishing the surface of the chemically strengthened glass substrate and then bringing the glass substrate into contact with the inorganic salt composition to perform the ion exchange is taken as a vertical axis, and the concentration of NaNO₃ in the inorganic salt composition is taken as a horizontal axis. FIG. 2C is a graph in which CS₅₀ of the chemically strengthened glass substrate obtained by partially polishing the surface of the chemically strengthened glass substrate and then bringing the glass substrate into contact with the inorganic salt composition to perform the ion exchange is taken as a vertical axis, and the concentration of NaNO₃ in the inorganic salt composition is taken as a horizontal axis.

As shown in FIG. 2C, when the concentration of NaNO₃ in the inorganic salt composition used for the ion exchange after the polishing increases, CS₅₀ increases, and a deep layer stress can be increased. On the other hand, as shown in FIG. 2B, as the concentration of NaNO₃ in the inorganic salt composition used for the ion exchange after the polishing increases, the CS₀ decreases. Therefore, by setting the concentration of NaNO₃ in the inorganic salt composition to an optimum range, it is possible to make the CS₀ and CS₅₀ compatible to introduce sufficient compressive stress to both the glass surface and the glass deep layer portion, and to improve the strength of the chemically strengthened glass substrate.

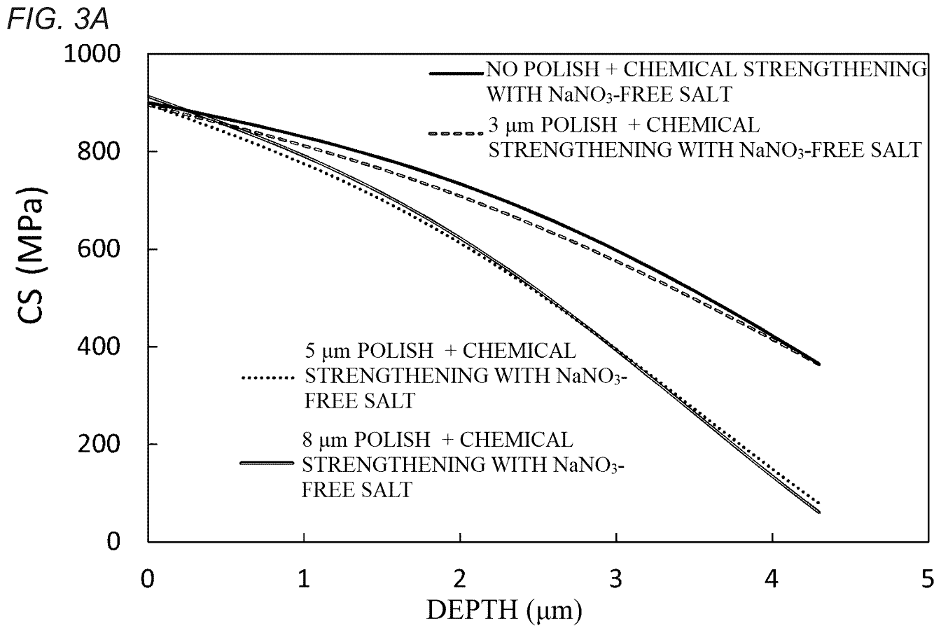

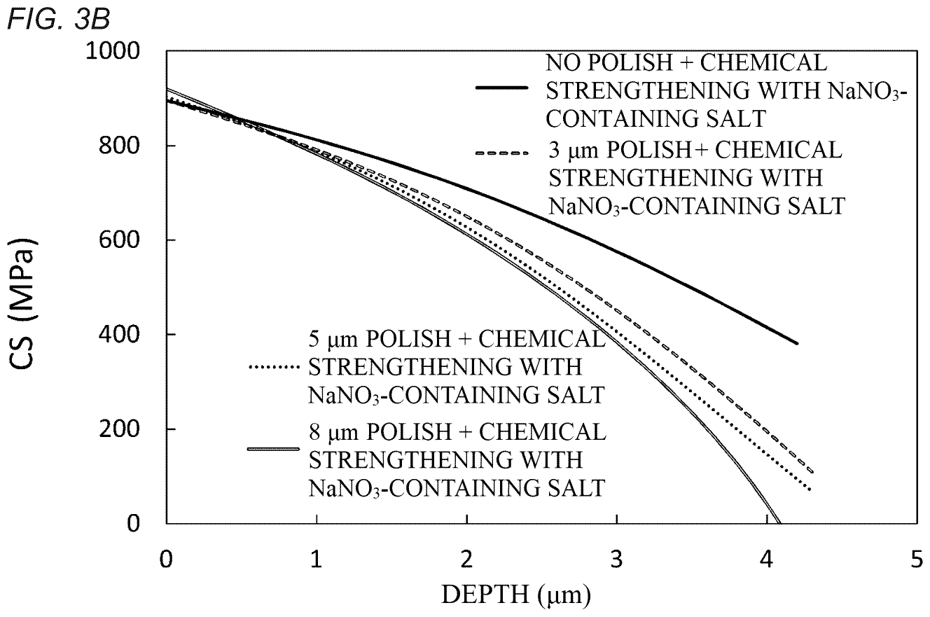

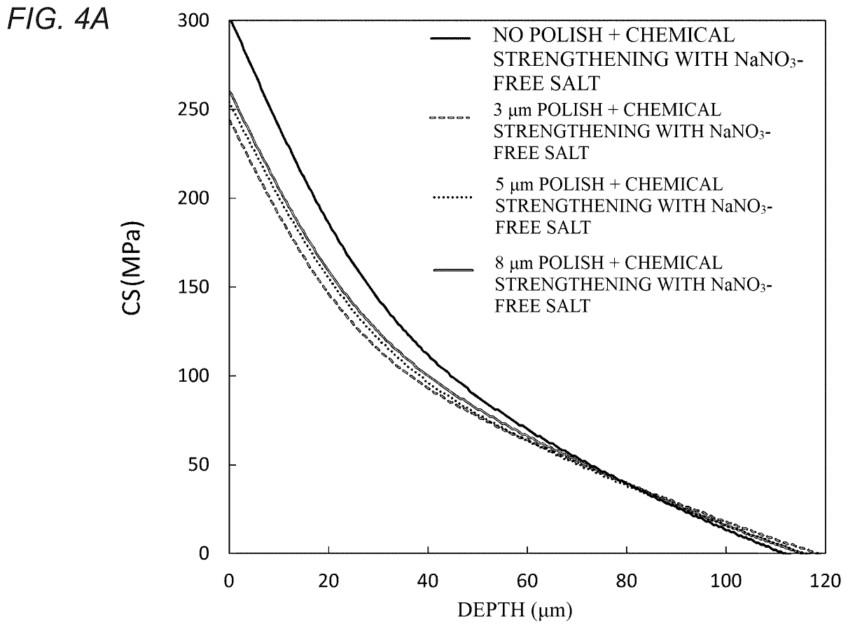

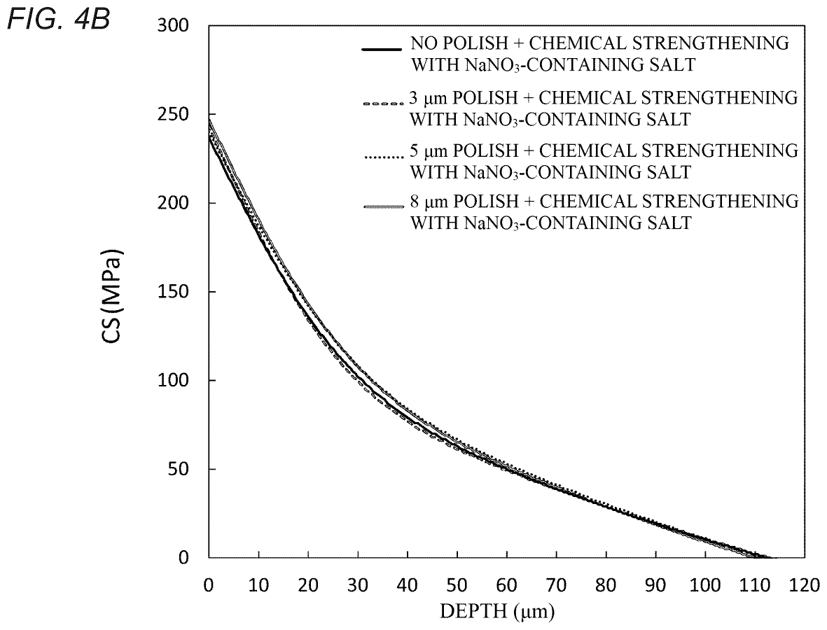

FIG. 3A and FIG. 4A are graphs showing a stress profile of a chemically strengthened glass substrate obtained by performing ion exchange after polishing using a NaNO₃-free salt. FIG. 3B and FIG. 4B are graphs showing a stress profile of a chemically strengthened glass substrate obtained by performing a chemical strengthening treatment after polishing using an inorganic salt composition (NaNO₃-containing salt) that was used a plurality of times for the chemical strengthening treatment and has a cumulative treated area of 0.5 m²/kg with respect to the glass substrate. The inorganic salt composition that has been used a plurality of times for the chemical strengthening treatment and has degraded tends to increase in concentration of NaNO₃ in accordance with a treatment amount.

In the present description, the cumulative treated area (m²/kg) means that the glass substrate having an area of 1 μm² is chemically strengthened with respect to 1 kg of an inorganic salt composition melt. The area of the glass substrate is a value obtained by multiplying a length of a long side and a length of a short side of the glass substrate, and is not a surface area of the glass substrate.

As shown in FIG. 4A and FIG. 4B, it can be seen that by using the inorganic salt composition that was used a plurality of times for the chemical strengthening treatment as the inorganic salt composition used for the ion exchange of the chemically strengthened glass substrate after the polishing, a deep layer stress of the chemically strengthened glass substrate can be effectively recovered as compared with the case of using an unused inorganic salt composition (of which a cumulative treated amount is 0 m²/kg). Further, as shown in FIG. 3A and FIG. 3B, it can be seen that by using the inorganic salt composition that was used a plurality of times for the chemical strengthening treatment as the inorganic salt composition used for the ion exchange of the chemically strengthened glass substrate after the polishing, a stress of the glass surface layer can be recovered to the same extent as in the case of using the unused inorganic salt composition (of which the cumulative treated amount is 0 m²/kg).

A contact temperature between the glass substrate and the inorganic salt composition is not particularly limited, and is preferably 360° C. or higher, more preferably 370° C. or higher, and still more preferably 380° C. or higher from the viewpoint of increasing an ion exchange rate and improving the productivity. Further, from the viewpoint of reducing volatilization of the salt, the contact temperature is preferably 500° C. or lower, more preferably 490° C. or lower, and yet still more preferably 480° C. or lower.

The contact time between the glass substrate and the inorganic salt composition is not particularly limited, and is preferably 5 minutes or more, more preferably 10 minutes or more, still more preferably 20 minutes or more, and yet still more preferably 30 minutes or more, from the viewpoint of reducing a variation in ion exchange level due to a time change. Further, from the viewpoint of improving the productivity, the time is preferably 8 hours or less.

Conditions for bringing the glass substrate into contact with the inorganic salt composition are, for example, preferably from 360° C. or higher and 500° C. or lower for 5 minutes or more and 8 hours or less, and more preferably 380° C. or higher and 450° C. or lower for 30 minutes or more and 2 hours or less.

In the inorganic salt composition used in the step (C), the cumulative treated area with respect to the glass substrate is preferably 0.2 m²/kg or more, more preferably 0.3 m²/kg or more, still more preferably 0.4 m²/kg or more, and particularly preferably 0.5 m²/kg or more. When the cumulative treated area of the inorganic salt composition with respect to the glass substrate is 0.2 m²/kg or more, the concentration of NaNO₃ in the inorganic salt composition is increased, and the compressive stress can be sufficiently introduced not only in the glass surface layer portion but also in the glass deep layer portion, whereby the life of the inorganic salt composition can be extended. An upper limit of the cumulative treated area of the inorganic salt composition with respect to the glass substrate is not particularly limited, and generally, the cumulative treated area is preferably 3.0 m²/kg or less, and more preferably 2.0 m²/kg or less.

In the first to fifth embodiments, the value obtained by dividing a strengthening expansion coefficient of the chemically strengthened glass substrate C by a strengthening expansion coefficient of the chemically strengthened glass substrate A is preferably 0.90 or more and 1.10 or less. By setting the value within the above range, it is possible to recycle a high-quality chemically strengthened glass substrate. The strengthening expansion coefficient is more preferably 1.08 or less, still more preferably 1.06 or less. The strengthening expansion coefficient is yet still more preferably 0.92 or more, and even yet still more preferably 0.94 or more. The strengthening expansion coefficient of the chemically strengthened glass substrate C is obtained by the formula described above in the section of <Measurement of Strengthening Expansion Coefficient>.

In the first to fifth embodiments, before or after the ion exchange in the step (C), an ion exchange may be performed with an inorganic salt composition containing a composition different from that of the ion exchange in the step (C). Such an aspect includes, for example, in the first to fifth embodiments, an embodiment of performing the ion exchange with the inorganic salt composition containing 90% by mass or more and 100% by mass or less of KNO₃ and 0% by mass or more and less than 5% by mass of NaNO₃ before the ion exchange in the step (C). An ion exchange time of the inorganic salt composition containing the composition different from that of the ion exchange in the step (C) is preferably ¼ or less, more preferably ⅕ or less, and still more preferably ⅙ or less of the ion exchange time in the step (A) described above.

<<Step (C′)>>

The step (C′) is a step of measuring the stress value of the chemically strengthened glass substrate C and determining whether the stress value satisfies the predetermined criterion after the step (C). In the present embodiment, when the stress value does not satisfy the predetermined criterion, the step (B) to the step (C′) are preferably repeated until the stress value satisfies the predetermined criterion. When the stress value satisfies the predetermined criterion, the step (D) is preferably performed.

The stress profile can be measured by a method using the scattered light photoelastic stress meter. The scattered light photoelastic stress meter is a stress measuring device including: a polarization phase difference variable member that changes a polarization phase difference of laser light by one wavelength or more with respect to a wavelength of the laser light; an imaging element that acquires a plurality of images by imaging, a plurality of times at predetermined time intervals, scattered light emitted when the laser beam having the varied polarization phase difference is incident on the strengthened glass; and a calculation unit that measures a periodic luminance change of the scattered light using the plurality of images, calculates a phase change of the luminance change, and calculates stress distribution in a depth direction from a surface of the strengthened glass based on the phase change (see WO2018/056121).

A method for measuring the stress profile using the scattered light photoelastic stress meter includes a method described in WO2018/056121. Examples of the scattered light photoelastic stress meter include SLP-1000 and SLP-2000 manufactured by Orihara industrial co., ltd. Combining attached software SlpIV (Ver.2019.01.10.001) with these scattered light photoelastic stress meters enables the highly accurate stress measurement.

CS₅₀, which is the compressive stress value at the depth of 50 μm from a surface of the chemically strengthened glass substrate C having a thickness of t [μm] obtained in the step (C), is preferably (140t−20) MPa or more, more preferably (140t−15) MPa or more, and still more preferably (140t−10) MPa or more. Further, CS₀, which is the compressive stress value of the glass surface of the chemically strengthened glass substrate C, is preferably 750 MPa or more, more preferably 800 MPa or more, and still more preferably 900 MPa or more.

The step (B) and the step (C) are steps of reworking the chemically strengthened glass substrate in which the result of the appearance inspection and the stress value do not satisfy the predetermined criterions, and these steps are also collectively referred to as a “polishing and reworking step”.

<<Step (D)>>

The step (D) is a step of, when the stress value of the chemically strengthened glass substrate C satisfies the predetermined criterion in the step (C′), further performing the appearance inspection of the chemically strengthened glass substrate C and determining whether the result of the appearance inspection satisfies the predetermined criterion. In the present embodiment, it is preferable to repeat the steps (B) to (D) until the result of the appearance inspection satisfies the predetermined criterion. The appearance inspection in the step (D) is the same as the appearance inspection in the step (A′).

(Shape Change)

(1) An embodiment in which the chemically strengthened glass substrate A is a chemically strengthened glass substrate having a flat surface portion and a curved surface portion on a main surface thereof and an end surface in a direction perpendicular to the main surface

As an embodiment of the present invention, in the case in which the chemically strengthened glass substrate A has the main surface and the end surface, the main surface includes the flat surface portion and the curved surface portion, and the end surface is formed in the direction perpendicular to the flat surface portion of the main surface,
a most protruding portion of the end surface in a horizontal direction with respect to the flat surface portion is defined as a point A,
a discontinuous point of the curved surface portion starting from the point A is defined as a point B,
an intersection point of a parallel line with respect to the flat surface portion starting from the point A and a normal line with respect to the flat surface portion starting from the point B is defined as a point C,
for the chemically strengthened glass substrate A in the step (A), a distance between the point A and the point C is defined as X₀, a distance between the point B and the point C is defined as Y₀, and a maximum thickness at a flat surface portion center is defined as to,
for the chemically strengthened glass substrate C obtained by repeating the step (B) to the step (D) n times, a distance between the point A and the point C is defined as Xₙ, a distance between the point B and the point C is defined as Yₙ, and the thickness at the flat surface portion center is defined as tₙ, it is preferable that a relational expression of (Xₙ/tₙ)/(X₀/t₀)>1, and (Yₙ/tₙ)/(Y₀/t₀)>1 are satisfied. Here, n is an integer of 1 or more. In a case in which the chemically strengthened glass substrate A includes the flat surface portion and the curved surface portion on the main surface, if there are the scratches on the outer surface or the foreign matters on the surface, particularly in the flat portion other than the curved surface portion, it is likely to cause the defect. When the relational expression is satisfied, the high-quality chemically strengthened glass substrate from which the scratches on the outer surface and the foreign matters on the surface, particularly in the flat surface portion are effectively removed is obtained.

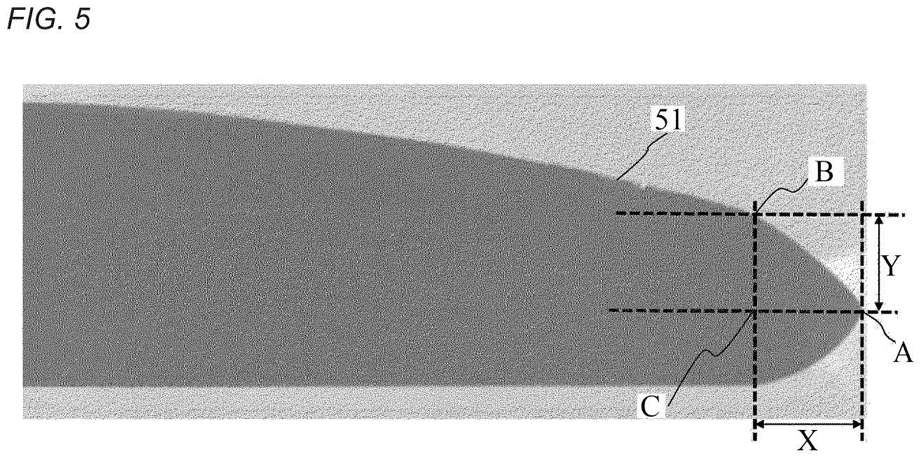

FIG. 5 is a schematic cross-sectional view showing the points A to C, X, and Y in a case in which a chemically strengthened glass substrate is a chemically strengthened glass substrate 51 that includes a flat surface portion and a curved surface portion on a main surface and has an end surface formed in a direction perpendicular to the flat surface portion of the main surface, as an embodiment of the present invention.

With respect to the point B, the “discontinuous point of the curved surface portion starting from the point A” is a point where a slope of a curved shape in the curved surface portion starting from the point A is obtained by differentiation, and a change in slope becomes maximum across the point.

X and Y in FIG. 5 are X₀ and Y₀ in the chemically strengthened glass substrate A in the step (A), and Xₙ and Yₙ in the chemically strengthened glass substrate C obtained by repeating the step (B) to the step (D) n times.

(2) An embodiment in which the chemically strengthened glass substrate A is a chemically strengthened glass substrate having a main surface and an end surface and including a flat surface portion and a bent portion on the main surface

As an embodiment of the present invention, in the case in which the chemically strengthened glass substrate A has the main surface and the end surface and includes the flat surface portion and the bent portion on the main surface,
in the chemically strengthened glass substrate C obtained by repeating the step (B) to the step (D) one or more times, when a maximum thickness of the bent portion from an inflection point of the bent portion to the end surface is defined as t_{c} and a thickness of a flat surface portion center is defined as t_{f}, t_{f}/t_{c} is preferably less than 0.96, and more preferably less than 0.94.

The inflection point of the bent portion is a point at which, when a substrate is observed from a direction perpendicular to a cross section, a tangent slope of a curved shape from a horizontal portion toward a corner portion is not zero at first, and represents a starting point of the bent portion. FIG. 11 is a schematic cross-sectional view showing a flat surface portion center 111, an inflection point 112 of a bent portion, and an end surface 113 in the case in which a chemically strengthened glass substrate A110 is a chemically strengthened glass substrate including a flat surface portion and a bent portion on a surface thereof, as an embodiment of the present invention. t_{c} is a distance from any point of the bent portion on the main surface to an intersection of a normal line of the point and a surface facing the main surface in a thickness direction.

In a method for producing a chemically strengthened glass substrate including a bent portion in the related art, since the bent portion is formed after polishing, a thickness is not uniform. On the other hand, the chemically strengthened glass substrate produced by a producing method of the present embodiment has a feature that a thickness of the flat surface portion center is smaller than the maximum thickness of the bent portion from the inflection point of the bent portion to the end surface. In the case in which the chemically strengthened glass substrate includes the flat surface portion and the bent portion on the main surface thereof, if there are the scratches on the outer surface or the foreign matters on the surface, particularly in the flat portion other than the bent portion, it is likely to cause the defect. When the relational expression is satisfied, the high-quality chemically strengthened glass substrate from which the scratches on the outer surface and the foreign matters on the surface, particularly on the flat surface portion are effectively removed is obtained.

An embodiment of the present invention includes a chemically strengthened glass substrate having a main surface and an end surface and including a flat surface portion and a bent portion on the main surface, in which when a maximum thickness of the bent portion from an inflection point of the bent portion to the end surface is defined as t_{c}′, and a thickness of a flat surface portion center is defined as t_{f}′, a relational expression, that is, t_{f}′/t_{c}′<0.96 is satisfied. t1′ and t2′ in this embodiment are the same as t1 and t2 described above.

(Design Function of Number of Steps)

In the present embodiment, when the number of times the step (B) and the step (C) are performed is defined as Z [times], a total amount of polishing per main surface of the chemically strengthened glass substrate C obtained in the step (C) is defined as a [μm], and a substrate thickness tolerance is defined as ±b [μm],
a relational expression, that is, Z [times]=(a×2)/(b×2)=a/b is preferably satisfied. Here, Z is an integer of 1 or more.

By satisfying the relational expression between the substrate thickness tolerance and the number of times of performing the polishing and reworking, a chemically strengthened glass substrate having an excellent appearance and an excellent strength characteristic can be efficiently produced. An upper limit of Z is not particularly limited, and is typically preferably 10 or less, more preferably 7 or less, and still more preferably 5 or less.

(Change in Yield Rate)

In the present embodiment, when the step (B) and the step (C) are performed k times and a yield rate in the chemically strengthened glass substrate C obtained in the step (C) after a k-th step (C) is defined as Pₖ, and a non-defective yield in the step (B) and the step (C) is defined as a,
a relational expression, that is, Pₖ≥Pₖ₋₁+(1−Pₖ₋₁)×a is preferably satisfied. K is an integer of 1 or more.

The yield rate refers to a ratio (%) of a chemically strengthened glass substrate that satisfies an appearance criterion. Specifically, when the step (B) and the step (C) are performed k times, the yield rate Pₖ refers to a ratio (%) of the number of the chemically strengthened glass substrates C satisfying the appearance criterion obtained after the k-th step (C) among a total number of the chemically strengthened glass substrates A prepared in the step (A).

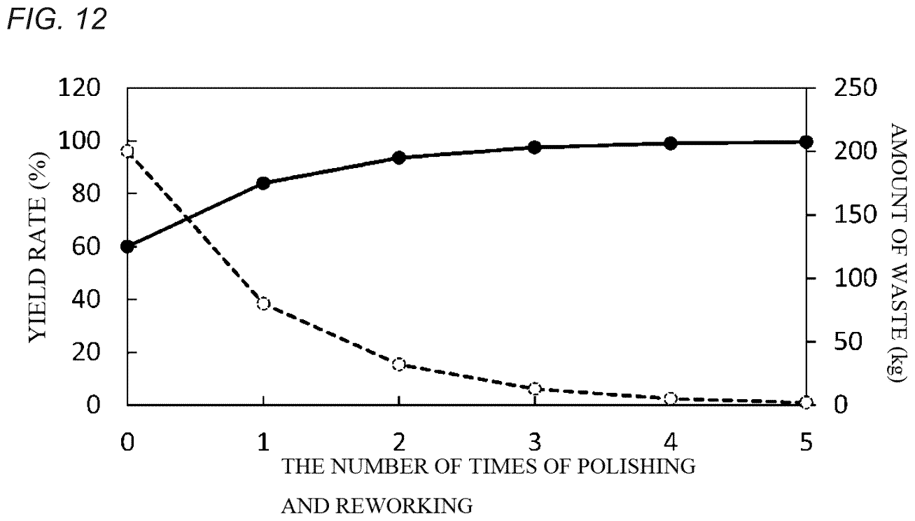

FIG. 12 is a graph in which the number of times of repeating the step (B) and the step (C) (the number of times of performing the polishing and reworking), the yield rate (solid line), and an amount of waste (dotted line) are estimated. When the yield rate satisfies the above relational expression, the chemically strengthened glass substrate having the excellent appearance and the excellent strength characteristic can be efficiently obtained. An upper limit of k is not particularly limited, and is typically 10 or less, more preferably 7 or less, and still more preferably 5 or less.

(Defective Rate)

In the present embodiment, a value obtained by subtracting a defective rate in the chemically strengthened glass substrate C obtained in the step (C) from a defective rate in the chemically strengthened glass substrate A in the step (A) is preferably 10% or more. The value is more preferably 15% or more, still more preferably 20% or more, and particularly preferably 30% or more. When the value is 10% or more, the chemically strengthened glass substrate having the excellent appearance and the excellent strength characteristic can be efficiently produced.

In the present description, the defective rate refers to a ratio (%) of a chemically strengthened glass substrate that does not satisfy the appearance criterion.

A defective rate of the chemically strengthened glass substrate A in the step (A) refers to a ratio (%) of the number of the chemically strengthened glass substrates A not satisfying the appearance criterion among a total number of the chemically strengthened glass substrates A prepared in the step (A). A defective rate of the chemically strengthened glass substrate C obtained in the step (C) refers to a ratio (%) of the number of the glass substrates C that do not satisfy the appearance criterion among a total number of the chemically strengthened glass substrates C obtained in the step (C).

(Stress Change)

In the present embodiment, it is preferable that a ratio of CS₅₀ (c) to CS₅₀ (a) represented by the following formula is 70% or more, and that CS₀ of the chemically strengthened glass substrate C obtained in the step (C) is 750 MPa or more.

CS₅₀(c)/CS₅₀(a)×100
CS₀: value of compressive stress in glass surface layer [MPa]
CS₅₀: value of compressive stress at depth of 50 μm from surface [MPa]
CS₅₀ (a): CS₅₀ of chemically strengthened glass substrate A in step (A) [MPa]
CS₅₀ (c): CS₅₀ of chemically strengthened glass substrate C in step (C) [MPa]

When the ratio of CS₅₀ (c) to the CS₅₀ (a) and CS₀ of the chemically strengthened glass substrate C obtained in the step (C) satisfy the above ranges, the sufficient compressive stress can be introduced into both the glass surface and the glass deep layer portion, and the chemically strengthened glass substrate having excellent strength can be produced.

The ratio of CS₅₀ (c) to the CS₅₀ (a) is preferably 70% or more, more preferably 75% or more, still more preferably 80% or more, and particularly preferably 85% or more. An upper limit of the ratio of CS₅₀ (c) to the CS₅₀ (a) is not particularly limited, and is preferably more than 100%, but is typically 100% or less.

CS₀ of the chemically strengthened glass substrate C obtained in the step (C) is preferably 750 MPa or more, more preferably 800 MPa or more, still more preferably 850 MPa or more, and particularly preferably 900 MPa or more. An upper limit of CS₀ of the chemically strengthened glass substrate C obtained in the step (C) is not particularly limited, and is typically 1200 MPa or less.

(Applications)

The chemically strengthened glass substrate produced in the present embodiment has a dimension that can be formed by an existing forming method, and may be finally cut into a size suitable for a purpose of use, or may be obtained by chemically strengthening a glass substrate cut into a predetermined size before chemical strengthening. That is, the chemically strengthened glass substrate can correspond to a size of a display of a tablet PC, a smart phone, or the like, glass for an automobile, window glass of a building or a house, and the like. An outer edge of the chemically strengthened glass substrate is not limited to a rectangular shape, and may have a circular or polygonal shape, or may be made of perforated glass.

### Reworking Method: Sixth Embodiment

A sixth embodiment of the present invention is a method for reworking a chemically strengthened glass substrate including the step (A) and the polishing and reworking step [steps (B) and (C)] in the method for producing a chemically strengthened glass substrate according to any one of the first to fifth embodiments.

In the present embodiment, a ratio of CS₅₀ (c) to CS₅₀ (a) represented by the following formula is 70% or more, and CS₀ of the chemically strengthened glass substrate obtained in the step (C) is 750 MPa or more.

CS₅₀(c)/CS₅₀(a)×100
CS₀: value of compressive stress in glass surface layer [MPa]
CS₅₀: value of compressive stress at depth of 50 μm from surface [MPa]
CS₅₀ (a): CS₅₀ of chemically strengthened glass substrate A in step (A) [MPa]
CS₅₀ (c): CS₅₀ of chemically strengthened glass substrate C in step (C) [MPa]

When the ratio of CS₅₀ (c) to the CS₅₀ (a) and CS₀ of the chemically strengthened glass substrate C obtained in the step (C) satisfy the above ranges, the sufficient compressive stress can be introduced into both the glass surface and the glass deep layer portion, and the strength of the chemically strengthened glass substrate can be improved.

The ratio of CS₅₀ (c) to CS₅₀ (a) is preferably 75% or more, more preferably 80% or more, and particularly preferably 85% or more. An upper limit of the ratio of CS₅₀ (c) to CS₅₀ (a) is not particularly limited, and is preferably more than 100%, but is typically 100% or less.

CS₀ of the chemically strengthened glass substrate C obtained in the step (C) is preferably 800 MPa or more, more preferably 850 MPa or more, and particularly preferably 900 MPa or more. An upper limit of CS₀ of the chemically strengthened glass substrate C obtained in the step (C) is not particularly limited, and is typically 1200 MPa or less.

### Reworking Method: Seventh Embodiment

A seventh embodiment according to the present invention is a method for reworking a chemically strengthened glass substrate, including in order the steps (A), (B), (C), (C′), and (D) in any one of the methods for producing a chemically strengthened glass substrate according the first to fifth embodiments. In the present embodiment, the steps (B) to (C′) are repeated until the stress value measured in the step (C′) satisfies the predetermined criterion, and the steps (B) to (D) are repeated until the result of the appearance inspection in the step (D) satisfies the predetermined standard.

In the present embodiment, a value obtained by subtracting a defective rate in the chemically strengthened glass substrate C obtained in the step (C) from a defective rate in the chemically strengthened glass substrate A in the step (A) is 10% or more, more preferably 15% or more, still more preferably 20% or more, and particularly preferably 30% or more. When the value is 10% or more, an appearance and a strength characteristic of the chemically strengthened glass substrate can be improved.

### Chemically Strengthened Glass Substrate: Eighth Embodiment

An eighth embodiment of the present invention is a chemically strengthened glass substrate having a main surface and an end surface and obtained by reworking a glass substrate. In the eighth embodiment, the reworking is preferably any one of the following steps.
(1) A step including polishing a surface of a chemically strengthened glass substrate, and then performing ion exchange by bringing the glass substrate into contact with an inorganic salt composition containing 90% by mass or more of KNO₃ and 1.0% by mass or more and 6.0% by mass or less of NaNO₃.
(2) A step including polishing a surface of a chemically strengthened glass substrate, and then performing ion exchange at least once by bringing the glass substrate into contact with an inorganic salt composition containing 90% by mass or more of KNO₃, 0% by mass or more and less than 5.0% by mass of NaNO₃, and 0% by mass or more and less than 1.0% by mass of LiNO₃.

### Method for Producing Chemically Strengthened Glass Substrate: Ninth Embodiment

A ninth embodiment of the present invention is a method for producing a chemically strengthened glass substrate in which a total discharge amount of waste is reduced by performing a recycling treatment including a polishing step and a chemical strengthening step. The polishing step in the ninth embodiment is the same as the step (B) in the first to fifth embodiments. The chemical strengthening step in the ninth embodiment is the same as the step (C) in any one of the first to fifth embodiments. The phrase “a total discharge amount of waste is reduced” means that the total discharge amount of the waste is reduced as compared with the case in which the recycling treatment in the ninth embodiment is not performed.

<Management Method>

In the case of mass-producing the chemically strengthened glass substrate by performing the ion exchange using a device, (1) a temperature of chemical strengthening, (2) a time of the chemical strengthening, and (3) composition of the inorganic salt composition are set in the device to perform the strengthening. However, when the strengthening is repeated, since alkali metal ions released from glass due to the ion exchange dissolve into the inorganic salt composition, there is a problem that (3) the composition of the inorganic salt composition (concentration of each component contained in the inorganic salt composition) change and are difficult to manage in the device. A state in which the components of the inorganic salt composition change may be referred to as “salt deterioration”, and when the salt deterioration progresses, the resulting chemically strengthened glass substrate may not satisfy an expected stress.

Hereinafter, as an aspect in which the chemically strengthened glass substrate is continuously produced using the device, a case will be specifically described in which chemically strengthened glass is immersed in the inorganic salt composition to perform first ion exchange, and another chemically strengthened glass substrate is immersed in the inorganic salt composition to perform second ion exchange. Each of the inorganic salt composition used in the first ion exchange and the inorganic salt composition used in the second ion exchange is preferably replaced at a timing at which the salt deterioration is confirmed. The salt deterioration is determined by either or both of a stress value of the chemically strengthened glass substrate after the first ion exchange and a stress value of the chemically strengthened glass substrate after the second ion exchange, and the replacement of the inorganic salt composition and the change of the chemical strengthening condition are carried out.

The stress value of the chemically strengthened glass substrate can be evaluated by using, for example, SLP-1000 manufactured by Orihara industrial co., ltd, and may be evaluated by a method described in WO2020/045093 (hereinafter abbreviated as a method A). When the stress value is evaluated by the method A, a plurality of parameters may be created based on information on the salt deterioration and the chemical strengthening condition, in other words, information on the first ion exchange and the second ion exchange. Examples of the information include the salt deterioration of the first ion exchange and/or the second ion exchange, a chemical strengthening time of the first ion exchange and/or the second ion exchange, and the information on a temperature of the inorganic salt composition in the first ion exchange and/or the second ion exchange. A plurality of parameters may be created based on the information.

In general, after the first ion exchange, the chemically strengthened glass substrate is washed with water and dried, and then the second ion exchange is performed in many cases. On the other hand, after the first ion exchange, the chemically strengthened glass substrate may be immersed (hereinafter abbreviated as prewashed) in an inorganic salt composition containing composition close to that of the inorganic salt composition in the second ion exchange and having a relatively low temperature, and then the second ion exchange may be performed without washing the glass substrate. In this case, since the alkali metal ions contained in the inorganic salt composition in the first ion exchange are dissolved in the inorganic salt composition used for the prewashing, there is a problem that the composition of the inorganic salt composition is changed when the inorganic salt composition is repeatedly used. This state is also referred to as salt deterioration, and since it is necessary to replace the inorganic salt composition, it is preferable to determine the timing of the salt replacement by the stress value of the chemically strengthened glass substrate after the prewashing or after the second ion exchange. The stress value can be evaluated by using, for example, SLP-1000 manufactured by Orihara industrial co., ltd, and may be evaluated by the method A. When the stress value is evaluated by the method A, a plurality of parameters may be created based on the information on the first ion exchange and the second ion exchange described above (for example, the information on the salt deterioration condition or the chemical strengthening condition), and information on the prewashing, and an optimum parameter may be used. Examples of the information on the prewashing include information on the salt deterioration in the prewashing, information on an immersion time in the prewashing, and the information on the temperature of the inorganic salt composition in the prewashing. Based on the information on the prewashing, a plurality of parameters may be made to create an optimal parameter.

The stress value of the chemically strengthened glass substrate after the polishing and reworking can be evaluated by using, for example, SLP-1000 manufactured by Orihara industrial co., ltd., and may be evaluated by the method A. When the stress value is evaluated by the method A, a plurality of parameters may be created based on the information on the first ion exchange, the information on the prewashing, the information on the second ion exchange, and the information on the reworking. Examples of the information on the reworking include information on the chemically strengthened glass substrate before the reworking (for example, the stress value), a processing condition at the time of reworking, and the number of times of the reworking.

### EXAMPLES

### 1. Evaluation Method

Various evaluations in this example were performed by the following analysis methods.

(Surface Stress)

A surface compressive stress value (unit: MPa) of the glass, a compressive stress value (CS, CSk, unit: MPa) at each depth, and a depth (DOL, unit: μm) of the compressive stress layer were measured using the film stress measurement (FSM-6000) manufactured by Orihara industrial co., ltd., and the scattered light photoelastic stress meter (SLP-2000) manufactured by Orihara industrial co., ltd.

(Tensile Stress)

The tensile stress value (CT, unit: MPa) was calculated by measuring stress distribution using a stress profile calculation method disclosed in JP2016-142600A and integrating the stress distribution with a thickness.

(Surface Scratch)

A determination person made a determination based on whether an abnormality such as a scratch was determined in terms of a standard determination when a distance between the glass and eyes of the determination person was set to 50 cm and an appearance of the glass was observed under illuminance of 5000 lux in a dark room environment. Here, in the above environment, a flaw that can be determined as a scratch having a width of 0.1 mm or more, or as a scratch having a width of 0.05 mm to 0.1 mm and a length of 1 mm or more was determined to be abnormal.

### 2. Production of Chemically Strengthened Glass

### Experimental Example 1: Relationship Between Chemical Strengthening Condition and Stress in Polishing and Reworking

[Step (A)]

The chemically strengthened glass substrate A was prepared by forming a compressive stress layer on a surface layer of a glass sheet of 50 mm×50 mm×0.65 mm which is glass a having the following composition (in terms of oxide by molar percentage) produced by a float method, under the ion exchange condition described below.

Glass a: 66% SiO₂, 11% Al₂O₃, 11% Li₂O, 6% Na₂O, 1.5% K₂O, 3% MgO, 0.2% CaO, and 1.3% ZrO₂

(Ion Exchange Condition)

In a first stage of ion exchange, the glass sheet described above was immersed for 2.5 hours in a molten salt bath of an inorganic salt composition containing 100% by mass of sodium nitrate held at 410° C. Thereafter, the glass sheet was taken out of the bath, and a surface of the glass sheet was washed and dried.

In a second stage of ion exchange, the dried glass sheet was immersed for 1 hour in a molten salt bath of an inorganic salt composition containing 99% by mass of potassium nitrate and 1% by mass of sodium nitrate held at 440° C. Thereafter, the obtained chemically strengthened glass substrate A was taken out of the bath, and the surface of the chemically strengthened glass substrate A was washed and dried.

[Step (B)]

As polishing slurry, cerium oxide having an average particle diameter (d50) of 1.2 μm was dispersed in water to prepare slurry having a specific gravity of 1.07. Next, a glass substrate was obtained by polishing each surface of the chemically strengthened glass substrate A prepared in the step (A) by 3 μm using the obtained slurry and a nonwoven fabric polishing pad having a Shore A hardness of 58° and a sinking amount at 100 g/cm² of 0.11 mm under a condition of a polishing pressure of 9.8 kPa.

[Step (C)]

The glass substrate having the surface polished in the step (B) was subjected to the ion exchange under the following condition to obtain the chemically strengthened glass substrate C.

(Ion Exchange Condition)

In the ion exchange, the dried glass sheet was immersed for 1 hour in a molten salt bath of an inorganic salt composition containing the following components held at 440° C. Thereafter, the glass sheet was taken out of the bath, and the surface of the glass sheet was washed and dried.
Example 1: 1% by mass of NaNO₃ and 99% by mass of KNO₃
Example 2: 2% by mass of NaNO₃ and 98% by mass of KNO₃
Example 3: 3% by mass of NaNO₃ and 97% by mass of KNO₃

Results of measuring a compressive stress of the chemically strengthened glass substrate C obtained above are shown in FIG. 2B and FIG. 2C. FIG. 2B is the graph in which CS₀ is taken as the vertical axis and the concentration of NaNO₃ in the inorganic salt composition is taken as the horizontal axis. FIG. 2C is the graph in which CS₅₀ is taken as the vertical axis and the concentration of NaNO₃ in the inorganic salt composition is taken as the horizontal axis.

As shown in FIG. 2C, when the concentration of NaNO₃ in the inorganic salt composition used for the ion exchange after the polishing was increased, CS₅₀ was increased. On the other hand, as shown in FIG. 2B, as the concentration of NaNO₃ in the inorganic salt composition used for the ion exchange after the polishing was increases, the CS₀ was decreased. From these results, it is found that by setting the concentration of NaNO₃ in the inorganic salt composition to the optimum range (1.0% by mass or more and 6.0% by mass or less), it is possible to have CS₀ and CS₅₀ compatible with each other, to introduce sufficient compressive stress to both the glass surface and the glass deep layer portion, and to improve the strength of the chemically strengthened glass substrate.

### Experimental Example 2: Change in Stress Profile Before and After Polishing and Reworking

[Step (A)]

A chemically strengthened glass substrate A in which a compressive stress layer was formed on a surface layer was prepared in the same manner as in the step (A) of Experimental Example 1.

[Step (B)]

Under the same condition as in the step (B) of Experimental Example 1, a glass substrate was obtained by polishing one main surface of the chemically strengthened glass substrate A obtained in the step (A) by 3 μm, 5 μm or 8 μm.

[Step (C)]

The glass substrate obtained in the step (B) was subjected to the ion exchange by being immersed for 1 hour in a molten salt bath of an inorganic salt composition shown below held at 440° C., and the chemically strengthened glass substrate C was obtained. Thereafter, the glass sheet was taken out of the bath, and the surface of the glass sheet was washed and dried.

NaNO₃-free salt: inorganic salt composition having a cumulative treated amount of 0 m²/kg with respect to the glass substrate and containing 100% by mass of KNO₃ and 0% by mass of NaNO₃

NaNO₃-containing salt: inorganic salt composition having a cumulative treated amount of 0.5 m²/kg with respect to the glass substrate, which has been used for the first stage of the ion exchange (100% by mass of NaNO₃, 2.5 hours at 410° C.) and the second stage of the ion exchange (99% by mass of KNO₃ and 1% by mass of NaNO₃, 1 hour at 440° C.)

The results of measuring the compressive stress of the obtained chemically strengthened glass substrate C are shown in FIG. 3A and FIG. 3B and FIG. 4A and FIG. 4B. FIG. 3A and FIG. 4A are the graphs showing the stress profile of the chemically strengthened glass substrate C obtained by performing the ion exchange after the polishing using the NaNO₃-free salt. FIG. 3B and FIG. 4B are graphs showing the stress profile of the chemically strengthened glass substrate C obtained by performing the chemical strengthening treatment after the polishing using the NaNO₃-containing salt.

As shown in FIG. 4B, it is found that by using the NaNO₃-containing salt as the inorganic salt composition used for the ion exchange of the glass substrate after the polishing, the deep layer stress of the chemically strengthened glass substrate can be effectively recovered as compared with the case in which the NaNO₃-free salt was used (FIG. 4A).

### Experimental Example 3: Estimation of Change in Yield Rate

It is found that when the step (B) and the step (C) were performed k times, the yield rate of the chemically strengthened glass substrate C obtained in the step (C) was defined as Pₖ, and the non-defective yield of the step (B) and the step (C) was defined as a, the following relational expression was satisfied.

Pₖ≥Pₖ₋₁+(1−Pₖ₋₁)×a

The yield rate refers to a ratio (%) of a chemically strengthened glass substrate that satisfies an appearance criterion as described below.

Yield rate Pₖ: when the steps (B) and (C) are performed k times, a ratio (%) of the number of glass substrates C that satisfy the appearance criterion, among a total number of the chemically strengthened glass substrates that are subjected to any one of the step (A) and k times of the steps (B) and (C)

FIG. 12 shows the graph in which the number of times of performing the step (B) and the step (C) (the number of times of performing the polishing and reworking) and the yield rate (solid line) and the amount of waste (dotted line) are estimated. FIG. 12 shows a transition when the yield rate is a=0.6 and Po=0.6. In FIG. 12, the yield rate is expressed in a percentage. Further, the amount of waste shown in FIG. 12 is obtained by estimating the amount of waste in the case of producing 500,000 cells of a cover glass for a smartphone having a thickness of 0.65 mm and a size of 5 inches. In FIG. 12, it is assumed that a defective product occurrence rate other than the chemical strengthening step is not included. As shown in FIG. 12, it can be found that as the number of the polishing and reworking increases, the yield rate increases, and the amount of waste decreases.

### Experimental Example 4: Estimation of Life Extension of Inorganic Salt Composition

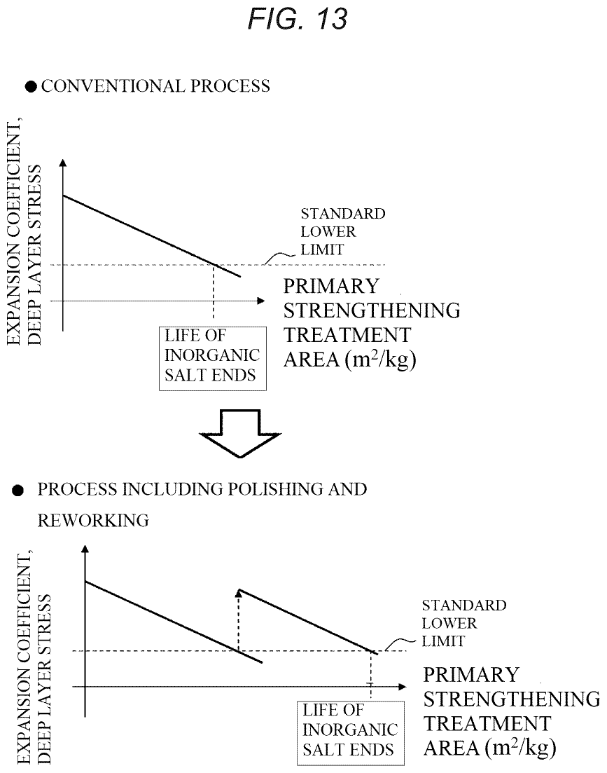

FIG. 13 shows a result of estimating life extension of the inorganic salt composition. As shown in a upper figure of FIG. 13, in a process of the conventional art, the inorganic salt composition was repeatedly used for the ion exchange to increase a treated area, so that the strengthening expansion coefficient and the deep layer stress of the obtained chemically strengthened glass substrate were reduced so as to fall below a standard lower limit, and the chemically strengthened glass substrate was discarded (salt life end). On the other hand, as shown in a lower figure of FIG. 13, even when the ion exchange is performed using the repeatedly used inorganic salt composition by the chemical strengthening (polishing and reworking) including the step (B) and the step (C), the deep layer stress of the obtained chemically strengthened glass substrate can be recovered. Therefore, according to the production method and the reworking method of the present invention, the inorganic salt composition can be used in a longer lifetime as compared with the method of the conventional art.

### Experimental Example 5: Shape Change Before and After Polishing and Reworking in Chemically Strengthened Glass Substrate Having Flat Surface Portion and Bent Portion on Main Surface and Including End Surface Formed in Direction Perpendicular to Flat Surface Portion of Main Surface

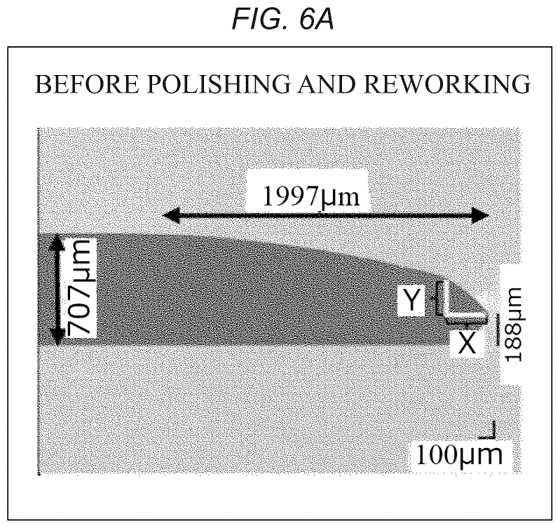

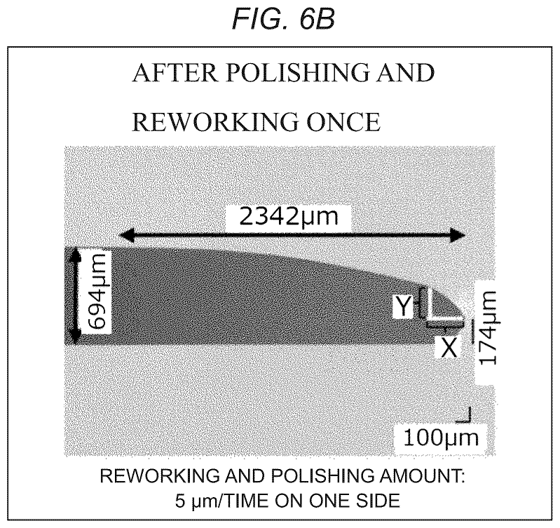

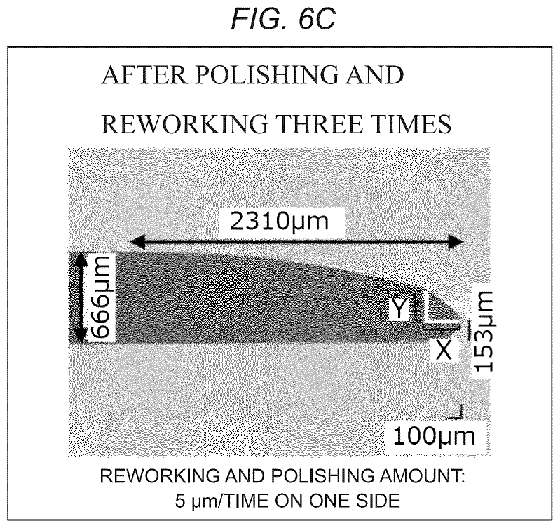

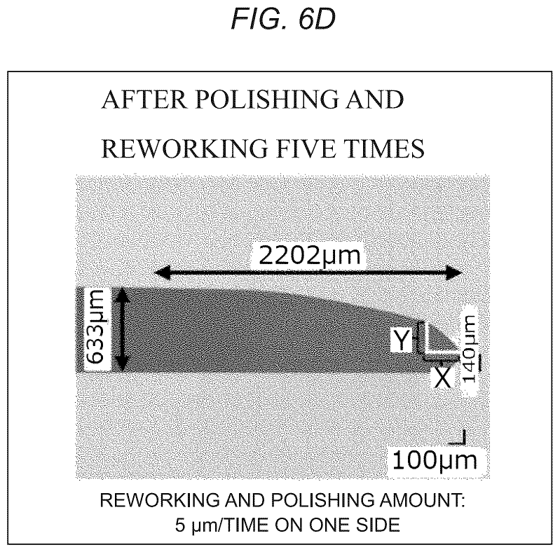

FIG. 6A to FIG. 6D show a change in shape of the end surface of the chemically strengthened glass substrate C obtained as the number of times of performing the step (B) and the step (C) (the number of times of performing polishing and reworking) increases in the producing method of the present invention.

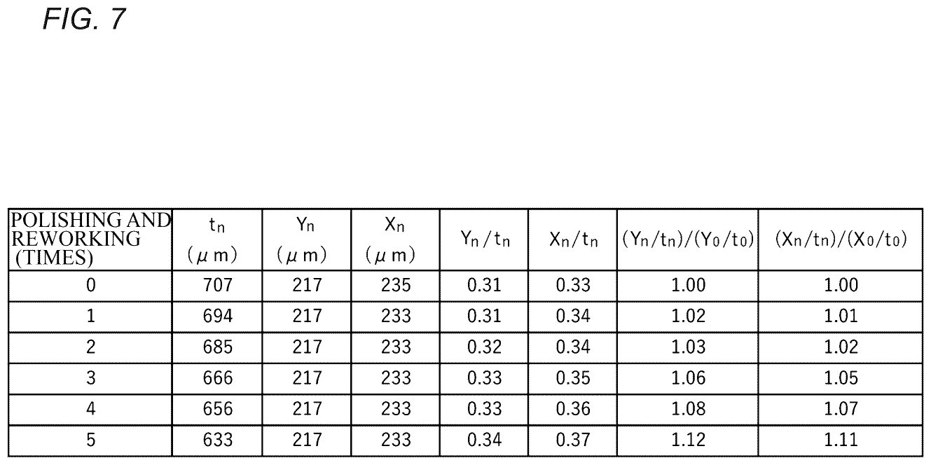

FIG. 7 shows values of Xₙ, Yₙ, Xₙ/tₙ, Yₙ/tₙ, (Xₙ/tₙ)/(X₀/t₀), and (Yₙ/tₙ)/(Y₀/t₀).

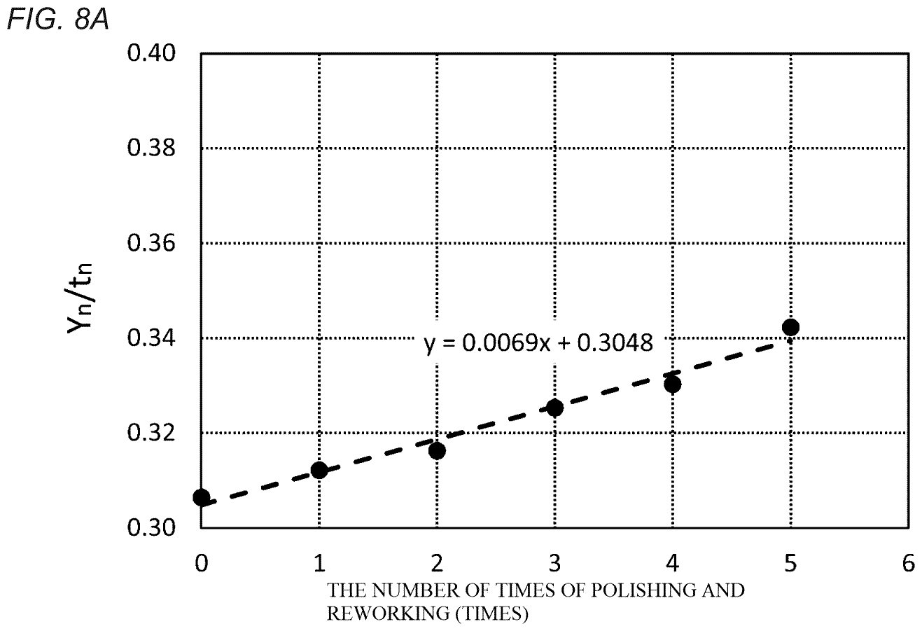

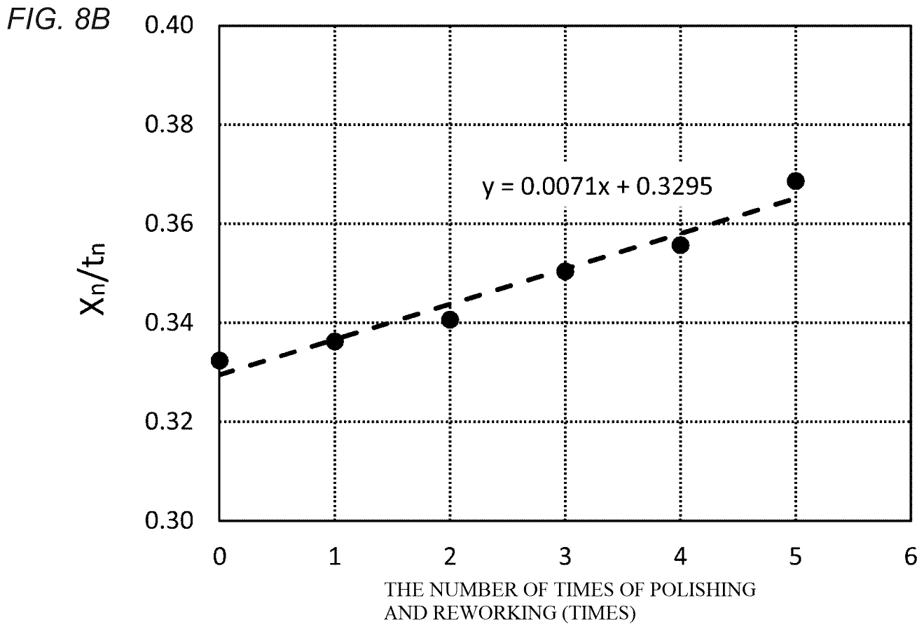

FIG. 8A and FIG. 8B are graphs in which Xₙ/tₙ, and Yₙ/tₙ are vertical axes, and the number of times of the polishing and reworking (times) is a horizontal axis.

FIG. 5 is the schematic diagram illustrating the points A to C, X, and Y. The points A to C, X₀, Y₀, and to, and Xₙ, Yₙ, and to are defined as follows.
Point A: the most protruding portion of the end surface in the horizontal direction with respect to the flat surface portion
Point B: the discontinuous point of the curved surface portion with the point A as the starting point
Point C: the intersection point of the parallel line with respect to the flat surface portion starting from the point A and the normal line with respect to the flat surface portion starting from the point B

In the step (A), the distance between the point A and the point C in the chemically strengthened glass substrate A is defined as X₀, the distance between the point B and the point C is defined as Y₀, and the maximum thickness at the flat surface portion center is defined as t₀.

For the chemically strengthened glass substrate C obtained by repeating the step (B) to the step (D) n times, the distance between the point A and the point C is defined as Xₙ, the distance between the point B and the point C is defined as Yₙ, and the thickness at the flat surface portion center is defined as tₙ.

As shown in FIG. 6A to FIG. 6D, FIG. 7, FIG. 8A and FIG. 8B, the amount of polishing at the flat surface portion center increases as the number of times of performing the step (B) and the step (C) increases, and the amount of polishing at the end surface is small, and thus it can be found that relational expressions, that is, (Xₙ/tₙ)/(X₀/t₀)>1 and (Yₙ/tₙ)/(Y₀/t₀)>1 are established at the end surface of the chemically strengthened glass substrate.

### Experimental Example 6: Shape Change Before and After Polishing and Reworking in Chemically Strengthened Glass Substrate Having Flat Surface Portion and Bent Portion on Main Surface

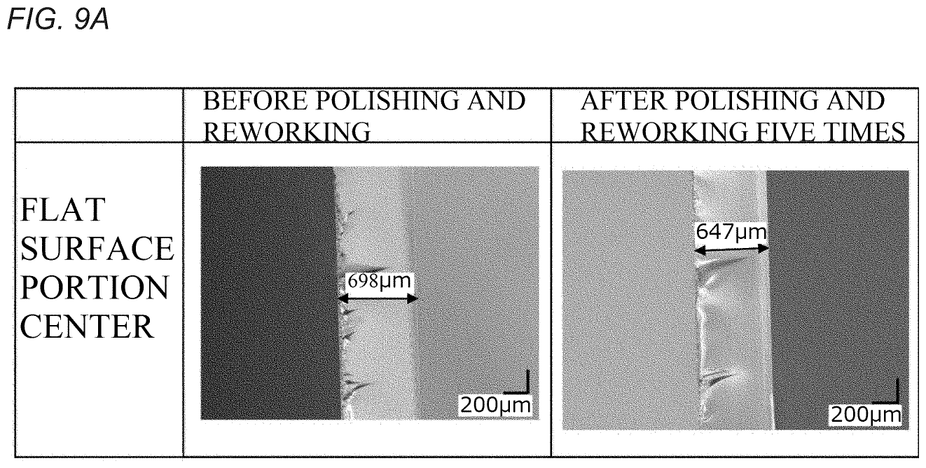

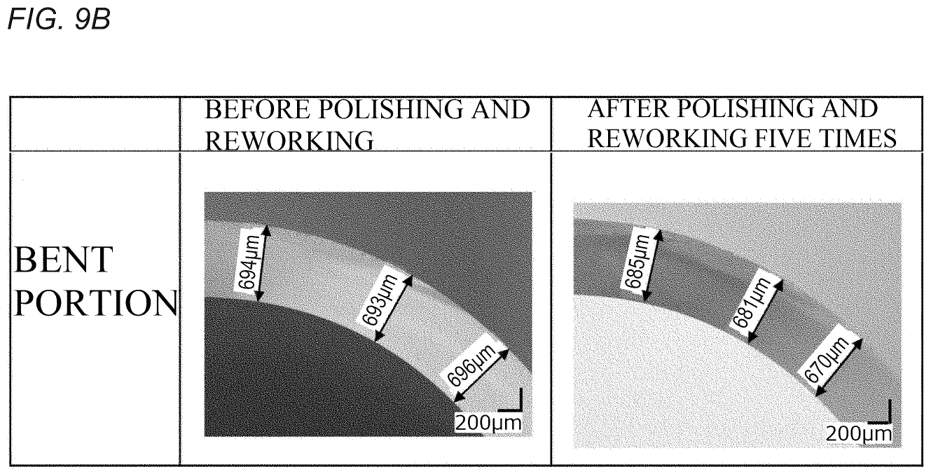

FIG. 9A and FIG. 9B show flat surface portion centers and corner portions of bent portions before and after the polishing and reworking in the case in which the chemically strengthened glass substrate is a chemically strengthened glass substrate having the flat surface portion and the bent portion on the main surface.

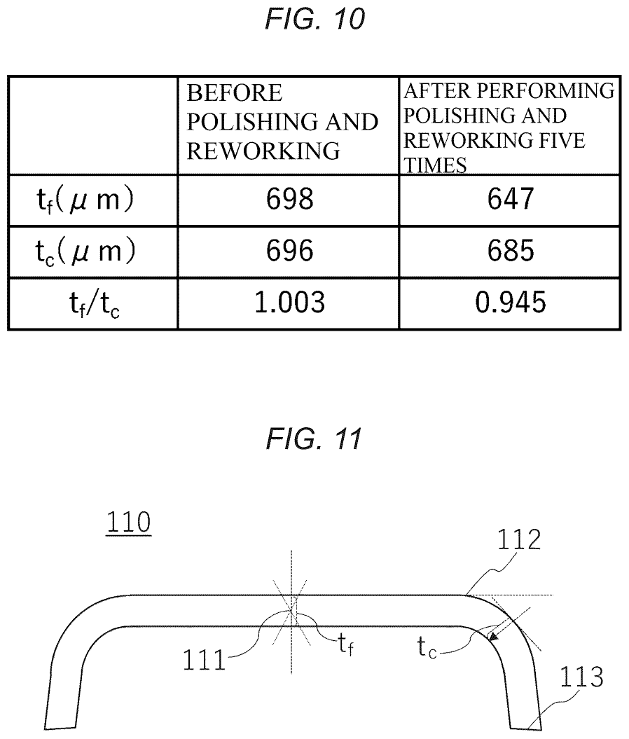

FIG. 10 is a shows t_{f}, t_{c}, and t_{f}/t_{c} of the chemically strengthened glass substrate having the flat surface portion and the bent portion on the main surface before the polishing and reworking and after the polishing and reworking is performed five times, in a case in which the maximum thickness of the bent portion from the inflection point to the end surface of the bent portion is defined as t_{c} and the thickness of the flat surface portion center is defined as t_{f}.

As shown in FIG. 9A and FIG. 9B and FIG. 10, as the number of times of performing the step (B) and the step (C) increases, the amount of polishing at the flat surface portion center increases, and since the amount of polishing at the bent portion is small, it can be found that the relational expression of t_{f}/t_{c}<0.96 is established in the chemically strengthened glass substrate.

### Experimental Example 7: Production and Evaluation of Chemically Strengthened Glass Substrate

[Step (A)]

A chemically strengthened glass substrate A in which a compressive stress layer was formed on a surface layer was prepared in the same manner as in Experimental Example 1 except that the ion exchange condition was changed to the following ion exchange condition.

(Ion Exchange Condition)

In a first stage of ion exchange, the glass sheet was immersed for 160 minutes in a molten salt bath of an inorganic salt composition containing 60% by mass of potassium nitrate and 40% by mass of sodium nitrate held at 410° C. Thereafter, the glass sheet was taken out of the bath, and the surface of the glass sheet was washed and dried.

In a second stage of the ion exchange, the dried glass sheet was immersed for 1 hour in a molten salt bath of an inorganic salt composition containing 99.3% by mass of potassium nitrate, 0.6% by mass of sodium nitrate, and 0.1% by mass of lithium nitrate held at 390° C. Thereafter, the obtained chemically strengthened glass substrate A was taken out of the bath, and the surface of the chemically strengthened glass substrate A was washed and dried.

[Step (B)]

A step (B) was performed in the same manner as in Experimental Example 1 to obtain a glass substrate in which each of surfaces of the chemically strengthened glass substrate A prepared in the step (A) was polished by 3 μm.

[Step (C)]

The glass substrate having the surface polished in the step (B) was subjected to the ion exchange under conditions shown in Tables 1 and 2 to obtain a chemically strengthened glass substrate C.

The obtained chemically strengthened glass substrate was evaluated by the following method. Results are shown in Tables 1 and 2. In Tables 1 and 2, Examples 8 to 10 are Comparative Examples, Examples 1 to 7 and Examples 13 to 17 are Working Examples, Examples 11, 12, 18, and 19 are Reference Examples.

[Measurement of Stress Performed by Scattered Light Photoelastic Stress Meter]

Using the scattered light photoelastic stress meter (SLP-2000 manufactured by Orihara industrial co., ltd.), the stress of the chemically strengthened glass substrate was measured by the method described in WO2018/056121. Further, the stress profile was calculated using attached software [SlpV (Ver.2019.11.07.001)] of the scattered light photoelastic stress meter (SLP-2000 manufactured by Orihara industrial co., ltd.).

A function used for obtaining the stress profile is σ(x)=[a₁×erfc (a₂×x)+a₃×erfc (a₄×x)+a₅]. aᵢ (i=1 to 5) is a fitting parameter, and erfc is a complementary error function. The complementary error function is defined by the following formula.

$$erfc ( x ) = 1 - erf ( x ) = \frac{2}{\sqrt{π}} {\int }_{x}^{∞} {e}^{- {t}^{2}} dt = {e}^{- {x}^{2}} erfc x ( x )$$

In the evaluation in this description, the fitting parameter was optimized by minimizing residual sum of squares of the obtained raw data and the function described above. Measurement processing conditions was single, and regarding measurement region processing adjustment items, an edge method was designated for the surface, 6.0 μm was designated for an inner surface edge, automatic was designated for inner left and right edges, and automatic (center of the sample film thickness) for an inner deep edge, and a fitting curve was designated for extension of a phase curve to a middle of a sample thickness.

From the obtained stress profile, values of CT, CS₅₀, CS₉₀, DOC, CS, DOL-tail, and a surface layer inclination were calculated by the method described above.

In Tables 1 and 2, each notation represents the following.
CT: maximum value of tensile stress measured by SLP-2000 (MPa)
CS₅₀: compressive stress value at depth of 50 μm from surface (MPa)
CS₉₀: compressive stress value at depth of 90 μm from surface (MPa)
DOC: compressive stress layer depth measured by SLP-2000 (μm)
CS₀: compressive stress on glass surface measured by FSM (MPa)
DOL-tail: compressive stress layer depth (μm) measured by FSM (curve approximation)
Surface layer inclination: absolute value of average inclination of stress profile from surface to DOL-tail (MPa/μm)
Ratio of CS₅₀ before and after reworking: ratio of CS₅₀ of Example to CS₅₀ of Reference Example in which step (A) is common and steps (B) and (C) are not performed
ratio of CS₉₀ before and after reworking: ratio of CS₉₀ of Example to CS₉₀ of Reference Example in which step (A) is common and steps (B) and (C) are not performed
ratio of CT before and after reworking: ratio of CT of Example to CT of Reference Example in which step (A) is common and steps (B) and (C) are not performed

[Strengthening Expansion Coefficient]

The strengthening expansion coefficient was determined by the following formula.

Strengthening expansion coefficient (%)={[(dimension of chemically strengthened glass substrate)−(dimension of glass substrate before chemical strengthening)]/(dimension of glass substrate before chemical strengthening)]}×100

In a dimension measurement, NEXIV (VMZ-S3020), which is an image measuring apparatus manufactured by Nikon Corporation, was used.

TABLE 1

| | | Example 1 | Example 2 | Example 3 | Example 4 | Example 5 | Example 6 |
|---|---|---|---|---|---|---|---|
| Glass | | a | a | a | a | a | a |
| Thickness t (mm) | | 0.6 | 0.6 | 0.6 | 0.6 | 0.6 | 0.6 |
| First ion | First molten salt composition | KNO₃ 60 | KNO₃ 60 | KNO₃ 60 | KNO₃ 60 | KNO₃ 60 | KNO₃ 60 |
| exchange | (mass %) | NaNO₃ 40 | NaNO₃ 40 | NaNO₃ 40 | NaNO₃ 40 | NaNO₃ 40 | NaNO₃ 38.5 |
| | | | | | | | LiNO₃ 1.5 |
| | Temperature (° C.) | 410 | 410 | 410 | 410 | 410 | 410 |
| | Time (min) | 160 | 160 | 160 | 160 | 160 | 160 |
| | Cumulative treated area of | 0 | 0 | 0 | 0 | 0 | 0.4 |
| | primary inorganic salt | | | | | | |
| | composition (m²/kg) | | | | | | |
| Second ion | Second molten salt | KNO₃ 99.3 | KNO₃ 99.3 | KNO₃ 99.3 | KNO₃ 99.3 | KNO₃ 99.3 | KNO₃ 99.3 |
| exchange | composition (mass %) | NaNO₃ 0.6 | NaNO₃ 0.6 | NaNO₃ 0.6 | NaNO₃ 0.6 | NaNO₃ 0.6 | NaNO₃ 0.6 |
| | | LiNO₃ 0.1 | LiNO₃ 0.1 | LiNO₃ 0.1 | LiNO₃ 0.1 | LiNO₃ 0.1 | LiNO₃ 0.1 |
| | Temperature (° C.) | 390 | 390 | 390 | 390 | 390 | 390 |
| | Time (min) | 60 | 60 | 60 | 60 | 60 | 60 |
| Polishing | Removal amount (μm/side) | 5 | 5 | 5 | 5 | 5 | 5 |
| First ion | First molten salt composition | KNO₃ 100 | KNO₃ 99.3 | KNO₃ 100 | KNO₃ 60 | KNO₃ 60 | KNO₃ 99.3 |
| exchange for | (mass %) | | NaNO₃ 0.6 | | NaNO₃ 40 | NaNO₃ 40 | NaNO₃ 0.6 |
| re- | | | LiNO₃ 0.1 | | | | LiNO₃ 0.1 |
| strengthening | Temperature (° C.) | 390 | 390 | 390 | 410 | 410 | 390 |
| | Time (min) | 90 | 90 | 60 | 10 | 40 | 90 |
| Second ion | Second molten salt | — | — | — | KNO₃ 99.3 | KNO₃ 99.5 | — |
| exchange for | composition (mass %) | | | | NaNO₃ 0.6 | LiNO₃ 0.5 | |
| re- | | | | | LiNO₃ 0.1 | | |
| strengthening | Temperature (° C.) | — | — | — | 390 | 390 | — |
| | Time (min) | — | — | — | 60 | 60 | — |
| FSM profile | CS₀ (MPa) | 1201 | 916 | 1249 | 947 | 762 | 934 |
| | DOL-tail (μm) | 3.4 | 3.5 | 3.4 | 3.0 | 3.0 | 3.4 |
| | Surface layer inclination | 319 | 261 | 349 | 317 | 272 | 269 |
| | (MPa/μm) | | | | | | |
| SLP profile | CS₅₀ (MPa) | 90 | 85 | 90 | 98 | 98 | 69 |
| | CS₉₀ (MPa) | 29 | 31 | 24 | 28 | 37 | 22 |
| | DOC (μm) | 113 | 117 | 109 | 111 | 118 | 113 |
| | CT (MPa) | 91 | 86 | 90 | 90 | 87 | 75 |
| | Ratio of CS₅₀ before and after | 0.85 | 0.80 | 0.85 | 0.93 | 0.93 | 0.86 |
| | reworking | | | | | | |
| | Ratio of CS₉₀ before and after | 1.07 | 1.15 | 0.89 | 1.04 | 1.37 | 1.22 |
| | reworking | | | | | | |
| | Ratio of CT before and after | 1.00 | 0.95 | 0.99 | 0.99 | 0.96 | 0.99 |
| | reworking | | | | | | |
| Strengthening | Dimensional change from | 0.106% | 0.101% | 0.103% | 0.104% | 0.105% | 0.082% |
| coefficient | unstrengthened product (%) | | | | | | |
| expansion | Ratio of strengthening | 1.03 | 0.98 | 1.00 | 1.02 | 1.02 | 1.00 |
| | expansion coefficient before | | | | | | |
| | and after reworking | | | | | | |
| | | Example 7 | Example 8 | Example 9 | Example 10 | Example 11 | Example 12 |
| Glass | | a | a | a | a | a | a |
| Thickness t (mm) | | 0.6 | 0.6 | 0.6 | 0.6 | 0.6 | 0.6 |
| First ion exchange | First molten salt | KNO₃ 60 | KNO₃ 60 | KNO₃ 60 | KNO₃ 60 | KNO₃ 60 | KNO₃ 60 |
| | composition (mass %) | NaNO₃ 38.5 | NaNO₃ 40 | NaNO₃ 40 | NaNO₃ 40 | NaNO₃ 40 | NaNO₃ 38.5 |
| | | LiNO₃ 1.5 | | | | | LiNO₃ 1.5 |
| | Temperature (° C.) | 410 | 410 | 410 | 410 | 410 | 410 |
| | Time (min) | 160 | 160 | 160 | 160 | 160 | 160 |
| | Cumulative treated area of | 0.4 | 0 | 0 | 0 | 0 | 0.4 |
| | primary inorganic salt | | | | | | |
| | composition (m²/kg) | | | | | | |
| Second ion | Second molten salt | KNO₃ 99.3 | KNO₃ 99.3 | KNO₃ 99.3 | KNO₃ 99.3 | KNO₃ 99.3 | KNO₃ 99.3 |
| exchange | composition (mass %) | NaNO₃ 0.6 | NaNO₃ 0.6 | NaNO₃ 0.6 | NaNO₃ 0.6 | NaNO₃ 0.6 | NaNO₃ 0.6 |
| | | LiNO₃ 0.1 | LiNO₃ 0.1 | LiNO₃ 0.1 | LiNO₃ 0.1 | LiNO₃ 0.1 | LiNO₃ 0.1 |
| | Temperature (° C.) | 390 | 390 | 390 | 390 | 390 | 390 |
| | Time (min) | 60 | 60 | 60 | 60 | 60 | 60 |
| Polishing | Removal amount (μm/side) | 5 | 5 | 5 | 5 | — | — |
| First ion exchange | First molten salt | KNO₃ 100 | KNO₃ 95 | KNO₃ 60 | KNO₃ 60 | — | — |
| for re- | composition (mass %) | | NaNO₃ 5 | NaNO₃ 40 | NaNO₃ 40 | | |
| strengthening | Temperature (° C.) | 390 | 390 | 410 | 410 | | — |
| | Time (min) | 90 | 90 | 80 | 40 | — | — |
| Second ion | Second molten salt | — | — | KNO₃ 99.3 | KNO₃ 99 | — | — |
| exchange for re- | composition (mass %) | | | NaNO₃ 0.6 | LiNO₃ 1 | | |
| strengthening | | | | LiNO₃ 0.1 | | | |
| | Temperature (° C.) | — | — | 390 | 390 | — | — |
| | Time (min) | — | — | 90 | 60 | — | — |
| FSM profile | CS₀ (MPa) | 1197 | 916 | 912 | 697 | 914 | 915 |
| | DOL-tail (μm) | 4.1 | 3.4 | 4.2 | 3.0 | 3.7 | 3.4 |
| | Surface layer inclination | 266 | 226 | 206 | 277 | 230 | 265 |
| | (MPa/μm) | | | | | | |
| SLP profile | CS₅₀ (MPa) | 66 | 98 | 98 | 92 | 106 | 80 |
| | CS₉₀ (MPa) | 18 | 15 | 30 | 40 | 27 | 18 |
| | DOC (μm) | 109 | 101 | 112 | 121 | 108 | 105 |
| | CT (MPa) | 77 | 103 | 104 | 81 | 91 | 76 |
| | Ratio of CS₅₀ before and | 0.83 | 0.93 | 0.93 | 0.87 | — | — |
| | after reworking | | | | | | |
| | Ratio of CS₉₀ before and | 1.00 | 0.56 | 1.11 | 1.48 | — | — |
| | after reworking | | | | | | |
| | Ratio of CT before and | 1.01 | 1.13 | 1.14 | 0.89 | — | — |
| | after reworking | | | | | | |
| Strengthening | Dimensional change from | 0.086% | 0.119% | 0.138% | 0.098% | 0.103% | 0.082% |
| expansion | unstrengthened product | | | | | | |
| coefficient | (%) | | | | | | |
| | Ratio of strengthening | 1.05 | 1.16 | 1.34 | 0.95 | — | — |
| | expansion coefficient | | | | | | |
| | before and after reworking | | | | | | |

TABLE 2

| | | Example 13 | Example 14 | Example 15 | Example 16 |
|---|---|---|---|---|---|
| Glass | | a | a | a | a |
| Thickness t (mm) | | 0.6 | 0.6 | 0.6 | 0.6 |
| First ion | First molten salt composition (mass %) | KNO₃ 60 | KNO₃ 60 | KNO₃ 60 | KNO₃ 60 |
| exchange | | NaNO₃ 40 | NaNO₃ 40 | NaNO₃ 38.5 | NaNO₃ 40 |
| | | | | LiNO₃ 1.5 | |
| | Temperature (° C.) | 410 | 410 | 410 | 410 |
| | Time (min) | 180 | 180 | 180 | 180 |
| | Cumulative treated area of primary | 0 | 0 | 0.4 | 0 |
| | inorganic salt composition (m²/kg) | | | | |
| Second ion | Second molten salt composition (mass %) | KNO₃ 99.3 | KNO₃ 99.3 | KNO₃ 99.3 | KNO₃ 99.3 |
| exchange | | NaNO₃ 0.6 | NaNO₃ 0.6 | NaNO₃ 0.6 | NaNO₃ 0.6 |
| | | LiNO₃ 0.1 | LiNO₃ 0.1 | LiNO₃ 0.1 | LiNO₃ 0.1 |
| | Temperature (° C.) | 390 | 390 | 390 | 390 |
| | Time (min) | 60 | 60 | 60 | 60 |
| Polishing | Removal amount (μm/side) | 2 | 5 | 2 | 5 |
| First ion | First molten salt composition (mass %) | KNO₃ 99.3 | KNO₃ 99.3 | KNO₃ 99 | KNO₃ 99 |
| exchange for re- | | NaNO₃ 0.6 | NaNO₃ 0.6 | NaNO₃ 1 | NaNO₃ 1 |
| strengthening | | LiNO₃ 0.1 | LiNO₃ 0.1 | | |
| | Temperature (° C.) | 390 | 390 | 390 | 390 |
| | Time (min) | 90 | 90 | 90 | 90 |
| Second ion | Second molten salt composition (mass %) | — | — | — | — |
| exchange for re- | Temperature (° C.) | — | — | — | — |
| strengthening | Time (min) | — | — | — | — |
| FSM profile | CS₀ (MPa) | 918 | 943 | 1055 | 1065 |
| | DOL-tail (μm) | 3.5 | 3.2 | 3.7 | 2.8 |
| | Surface layer inclination (MPa/μm) | 250 | 286 | 258 | 344 |
| SLP profile | CS₅₀ (MPa) | 96 | 93 | 80 | 99 |
| | CS₉₀ (MPa) | 34 | 31 | 20 | 23 |
| | DOC (μm) | 117 | 116 | 108 | 107 |
| | CT (MPa) | 90 | 89 | 87 | 97 |
| | Ratio of CS₅₀ before and after reworking | 0.91 | 0.89 | 0.98 | 0.94 |
| | Ratio of CS₉₀ before and after reworking | 1.55 | 1.41 | 1.05 | 1.05 |
| | Ratio of CT before and after reworking | 0.95 | 0.94 | 1.12 | 1.02 |
| Strengthening | Dimensional change from unstrengthened | 0.105% | 0.101% | 0.099% | 0.109% |
| expansion | product (%) | | | | |
| coefficient | Ratio of strengthening expansion coefficient | 0.98 | 0.95 | 1.18 | 1.02 |
| | before and after reworking | | | | |

| | | Example 17 | Example 18 | Example 19 |
|---|---|---|---|---|
| Glass | | a | a | a |
| Thickness t (mm) | | 0.6 | 1.6 | 2.6 |
| First ion | First molten salt composition (mass %) | KNO₃ 60 | KNO₃ 60 | KNO₃ 60 |
| exchange | | NaNO₃ 38.5 | NaNO₃ 40 | NaNO₃ 38.5 |
| | | LiNO₃ 1.5 | | LiNO₃ 1.5 |
| | Temperature (° C.) | 410 | 410 | 410 |
| | Time (min) | 180 | 180 | 180 |
| | Cumulative treated area of primary | 0.4 | 0 | 0.4 |
| | inorganic salt composition (m²/kg) | | | |
| Second ion | Second molten salt composition | KNO₃ 99.3 | KNO₃ 99.3 | KNO₃ 99.3 |
| exchange | (mass %) | NaNO₃ 0.6 | NaNO₃ 0.6 | NaNO₃ 0.6 |
| | | LiNO₃ 0.1 | LiNO₃ 0.1 | LiNO₃ 0.1 |
| | Temperature (° C.) | 390 | 390 | 390 |
| | Time (min) | 60 | 60 | 60 |
| Polishing | Removal amount (μm/side) | 5 | — | — |
| First ion | First molten salt composition (mass %) | KNO₃ 99.3 | — | — |
| exchange for re- | | NaNO₃ 0.6 | | |
| strengthening | | LiNO₃ 0.1 | | |
| | Temperature (° C.) | 390 | — | — |
| | Time (min) | 90 | — | — |
| Second ion | Second molten salt composition | — | — | — |
| exchange for re- | Temperature (° C.) | — | — | — |
| strengthening | Time (min) | — | — | — |
| FSM profile | CS₀ (MPa) | 953 | 916 | 930 |
| | DOL-tail (μm) | 3.0 | 3.5 | 3.2 |
| | Surface layer inclination (MPa/μm) | 312 | 248 | 292 |
| SLP profile | CS₅₀ (MPa) | 72 | 105 | 82 |
| | CS₉₀ (MPa) | 22 | 22 | 19 |
| | DOC (μm) | 112 | 105 | 106 |
| | CT (MPa) | 76 | 95 | 78 |
| | Ratio of CS₅₀ before and after reworking | 0.88 | — | — |
| | Ratio of CS₉₀ before and after reworking | 1.16 | — | — |
| | Ratio of CT before and after reworking | 0.97 | — | — |
| Strengthening | Dimensional change from | 0.085% | 0.107% | 0.083% |
| expansion | unstrengthened product (%) | | | |
| coefficient | Ratio of strengthening expansion | 1.02 | — | — |
| | coefficient before and after reworking | | | |

As shown in Tables 1 and 2, according to Examples 1 to 7 and Examples 13 to 17 which are the producing methods of the present invention, it is found that as compared with Examples 11, 12, 18 and 19 which are Reference Examples and Examples 8 to 10 which are Comparative Examples, it is possible to effectively increase the compressive stress value not only in the glass surface layer portion but also in the glass deep layer portion.

### INDUSTRIAL APPLICABILITY

According to the method for producing a chemically strengthened glass substrate and the method for reworking the chemically strengthened glass substrate of the present invention, a chemically strengthened glass substrate that does not satisfy a desired appearance criterion after chemical strengthening can be recycled as a high-quality chemically strengthened glass substrate having an excellent appearance and an excellent strength characteristic. Accordingly, a yield rate can be improved, and industrial waste can be reduced. The chemically strengthened glass substrate obtained by the method for producing the chemically strengthened glass substrate and the method for reworking the same of the present invention can be used as cover glass for a display such as a mobile phone, a digital camera or a touch panel display.

Although the present invention has been described in detail and by reference to the specific embodiments, it is apparent to one skilled in the art that various modifications or changes can be made without departing the spirit and scope of the present invention.

This application is based on Japanese Patent Application No. 2022-079823 filed on May 13, 2022, Japanese Patent Application No. 2022-166402 filed on Oct. 17, 2022, and Japanese Patent Application No. 2023-011178 filed on Jan. 27, 2023, the disclosure of which is incorporated herein by reference.

### REFERENCE SIGNS LIST

51, 110 Chemically strengthened glass substrate
111 Flat surface portion center
112 Inflection point of bent portion
113 End surface

What is claimed is:

1. A method for producing a chemically strengthened glass substrate, the method comprising the following steps (A) to (C):
(A) preparing a chemically strengthened glass substrate A having a main surface and an end surface;
(B) obtaining a glass substrate by polishing a surface of the chemically strengthened glass substrate A; and
(C) performing ion exchange by bringing the glass substrate into contact with an inorganic salt composition comprising 90% by mass or more of KNO₃ and 1.0% by mass or more and 6.0% by mass or less of NaNO₃ to obtain a chemically strengthened glass substrate C.

2. A method for producing a chemically strengthened glass substrate, the method comprising the following steps (A) to (C):
(A) preparing a chemically strengthened glass substrate A having a main surface and an end surface;
(B) obtaining a glass substrate by polishing a surface of the chemically strengthened glass substrate A; and
(C) performing ion exchange at least once by bringing the glass substrate into contact with an inorganic salt composition comprising 90% by mass or more of KNO₃, 0% by mass or more and less than 5.0% by mass of NaNO₃, and 0% by mass or more and less than 1.0% by mass of LiNO₃ to obtain a chemically strengthened glass substrate C.

3. The method for producing a chemically strengthened glass substrate according to claim 1,
wherein,
a value obtained by dividing a tensile stress CT (MPa) of the chemically strengthened glass substrate C by a tensile stress CT of the chemically strengthened glass substrate A is 0.90 or more and 1.20 or less.

4. The method for producing a chemically strengthened glass substrate according to claim 1,
wherein,
a value obtained by dividing a strengthening expansion coefficient of the chemically strengthened glass substrate C by a strengthening expansion coefficient of the chemically strengthened glass substrate A is 0.90 or more and 1.10 or less, the strengthening expansion coefficient being defined by the following formula,
strengthening expansion coefficient (%)={[(dimension of chemically strengthened glass substrate)−(dimension of glass substrate before chemical strengthening)]/(dimension of glass substrate before chemical strengthening)}×100.

5. The method for producing a chemically strengthened glass substrate according to claim 1, the method further comprising the following step (A′) between the step (A) and the step (B):
(A′) performing appearance inspection on the surface of the chemically strengthened glass substrate A,
wherein,
when it is determined that a result of the appearance inspection does not satisfy a predetermined criterion, the step (B) is performed.

6. The method for producing a chemically strengthened glass substrate according to claim 1,
wherein,
the step (B) and the step (C) are repeated.

7. The method for producing a chemically strengthened glass substrate according to claim 1, the method further comprising the following step (C′) after the step (C):
(C′) measuring a stress value of the chemically strengthened glass substrate C, and determining whether the stress value satisfies a predetermined criterion,
wherein,
steps of the step (B) to the step (C′) are repeated until the stress value satisfies the predetermined criterion.

8. The method for producing a chemically strengthened glass substrate according to claim 7, when the stress value satisfies the predetermined criterion in the step (C′), the method further comprising the following step (D):
(D) performing appearance inspection of the chemically strengthened glass substrate C and determining whether a result of the appearance inspection satisfies a predetermined criterion,
wherein,
steps of the step (B) to the step (D) are repeated until the result of the appearance inspection satisfies the predetermined criterion.

9. The method for producing a chemically strengthened glass substrate according to claim 1,
wherein,
in the step (B), a polishing amount per the main surface of the chemically strengthened glass substrate A is 0.5 μm or more.

10. The method for producing a chemically strengthened glass substrate according to claim 7,
wherein,
the chemically strengthened glass substrate A has the main surface and the end surface, the main surface includes a flat surface portion and a curved surface portion, and the end surface is formed in a direction perpendicular to the flat surface portion of the main surface, and
the following relational expressions are satisfied:
(Xₙ/tₙ)/(X₀/t₀)>1; and
(Yₙ/tₙ)/(Y₀/t₀)>1,
provided that,
n is an integer of 1 or more,
for the chemically strengthened glass substrate A in the step (A), a distance between a point A and a point C is defined as X₀, a distance between a point B and the point C is defined as Y₀, and a maximum thickness at a flat surface portion center is defined as to,
for the chemically strengthened glass substrate C obtained by repeating steps of the step (B) to the step (D) n times, a distance between the point A and the point C is defined as Xₙ, a distance between the point B and the point C is defined as Yₙ, and a thickness at the flat surface portion center is defined as tₙ,
the point A is a most protruding portion of the end surface in a horizontal direction with respect to the flat surface portion,
the point B is a discontinuous point of the curved surface portion starting from the point A, and
the point C is an intersection point of a parallel line with respect to the flat surface portion starting from the point A and a normal line with respect to the flat surface portion starting from the point B.

11. The method for producing a chemically strengthened glass substrate according to claim 7,
wherein,
the chemically strengthened glass substrate A has the main surface and the end surface, and the main surface includes a flat surface portion and a bent portion, and
the following relational expression is satisfied:
t_{f}/t_{c}<0.96,
provided that,
for the chemically strengthened glass substrate C obtained by repeating steps of the step (B) to the step (D) one or more times, a maximum thickness of the bent portion from an inflection point of the bent portion to the end surface is defined as t_{c} and a thickness of a flat surface portion center is defined as t_{f}.

12. A chemically strengthened glass substrate,
having a main surface and an end surface,
the main surface including a flat surface portion and a bent portion, and
satisfying the following relational expression:
t_{f}′/t_{c}′<0.96,
provided that,
a maximum thickness of the bent portion from an inflection point of the bent portion to the end surface is defined as t_{c}′, and a thickness of a flat surface portion center is defined as t_{f}′.

13. The method for producing a chemically strengthened glass substrate according to claim 1, when the step (B) and the step (C) are performed Z [times], a total polishing amount per a main surface of the chemically strengthened glass substrate C obtained in the step (C) is defined as a [μm], and a substrate thickness tolerance is defined as ±b [μm], satisfying the following relational expression:
Z[times]=a/b,
provided that Z is an integer of 1 or more.

14. The method for producing a chemically strengthened glass substrate according to claim 1, when the step (B) and the step (C) are performed k times, a yield rate for the chemically strengthened glass substrate C obtained in the step (C) is defined as Pₖ, and a non-defective yield in the step (B) and the step (C) is defined as a, satisfying the following relational expression:
Pₖ≥Pₖ₋₁+(1−Pₖ₋₁)×a,
provided that k is an integer of 1 or more.

15. The method for producing a chemically strengthened glass substrate according to claim 1,
wherein,
a value obtained by subtracting a defective rate in the chemically strengthened glass substrate C obtained in the step (C) from a defective rate in the chemically strengthened glass substrate A in the step (A) is 10% or more.

16. The method for producing a chemically strengthened glass substrate according to claim 1,
wherein,
a ratio of CS₅₀ (c) to CS₅₀ (a) represented by the following formula is 70% or more:
CS₅₀(c)/CS₅₀(a)×100, and
the chemically strengthened glass substrate C obtained in the step (C) has CS₀ of 750 MPa or more,
provided that,
a value of a compressive stress in a glass surface layer is defined as CS₀ [MPa], and a value of a compressive stress at a depth of 50 μm from a glass surface is defined as CS₅₀ [MPa], and
CS₅₀ [MPa] of the chemically strengthened glass substrate A in the step (A) is defined as CS₅₀ (a), and CS₅₀ [MPa] of the chemically strengthened glass substrate C in the step (C) is defined as CS₅₀ (c).

17. The method for producing a chemically strengthened glass substrate according to claim 1,
wherein,
the inorganic salt composition in the step (C) has a cumulative treated area of 0.2 m²/kg or more with respect to the glass substrate.

18. The method for producing a chemically strengthened glass substrate according to claim 1,
wherein,
the ion exchange in the step (C) is performed under a condition of 360° C. or higher and 450° C. or lower for 5 minutes or more and 8 hours or less.

19. A method for reworking a chemically strengthened glass substrate comprising the method for producing a chemically strengthened glass substrate according to claim 1,
wherein,
a ratio of CS₅₀ (c) to CS₅₀ (a) represented by the following formula is 70% or more:
CS₅₀(c)/CS₅₀(a)×100, and
the chemically strengthened glass substrate obtained in the step (C) has CS₀ of 750 MPa or more,
provided that,
a value of a compressive stress in a glass surface layer is defined as CS₀ [MPa], and a value of a compressive stress at a depth of 50 μm from a glass surface is defined as CS₅₀ [MPa], and
CS₅₀ [MPa] of the chemically strengthened glass substrate A in the step (A) is defined as CS₅₀ (a), and CS₅₀ [MPa] of the chemically strengthened glass substrate C in the step (C) is defined as CS₅₀ (c).

20. A method for producing a chemically strengthened glass substrate, the method comprising reducing a total discharge amount of waste by a recycling treatment comprising polishing and chemical strengthening.
